(19) United States
(12) Patent Application Publication
(10) Pub. No.: US 2018/0188830 A1
(43) Pub. Date: Jul. 5, 2018

(54) ELECTRONIC DEVICE

(71) Applicant: LG ELECTRONICS INC., Seoul (KR)

(72) Inventors: Sumi KIM, Seoul (KR); Choonghwan SHIN, Seoul (KR); Byunghwa LEE, Seoul (KR); Sukchan JUNG, Seoul (KR); Hyunju OH, Seoul (KR)

(73) Assignee: LG ELECTRONICS INC., Seoul (KR)

(21) Appl. No.: 15/736,722

(22) PCT Filed: Aug. 5, 2015
(86) PCT No.: PCT/KR2015/008204

§ 371 Date: Dec. 14, 2017

(30) Foreign Application Priority Data
Jun. 19, 2015 (KR) 10-2015-0087328
Jun. 19, 2015 (KR) 10-2015-0087331
Jun. 24, 2015 (KR) 10-2015-0089950

(51) Int. Cl. G06F 3/0346; G06F 3/0354

(52) U.S. Cl. CPC G06F 3/0346; G06F 3/03545

(57) ABSTRACT

An electronic device is disclosed. The electronic device according to the present invention comprises: a housing elongated to be long; a tip coupled to one end of the housing; a motion sensor located at at least one side of the housing; and a control unit for operating in a first mode of recording, in a memory, content corresponding to a motion of the tip or the housing on the basis of a user's operation acquired through the motion sensor and/or a second mode of performing a specific function on the basis of a user's operation, wherein mode switching between the first mode and the second mode is performed when the user's operation acquired through the motion sensor corresponds to a preset operation.

### BACKGROUND OF THE INVENTION

### Field of the Invention

The present invention relates to an electronic device capable of operating in different modes depending on user manipulation performed thereon.

### Related Art

Electronic devices can be divided into a mobile type and a fixed type according to mobility. Mobile electronic devices can be divided into a portable electronic device and a stationary type electronic device according to user portability.

Electronic devices are diversified. For example, electronic devices are divided into conventional types such as a bar type and wearable types which can be used in various situations.

Recently, research on electronic devices taking the forms of existing objects is in progress in order to provide analog sensibility.

### SUMMARY OF THE INVENTION

An object of the present invention is to solve the aforementioned problem and other problems. Another object of the present invention is to provide an electronic device capable of recording motion.

Yet another object of the present invention is to provide an electronic device capable of being controlled according to motion.

Still another object of the present invention is to provide an electronic device capable of switching modes according to a specific operation.

Further another object of the present invention is to provide an electronic device capable of switching modes according to a switch.

Another object of the present invention is to provide an electronic device capable of extending a display.

Yet another object of the present invention is to provide an electronic device including a roll type display.

According to an aspect of the present invention to accomplish the above objects or other objects, there is provided an electronic device including: a housing elongated to extend; a tip coupled to one end of the housing; a motion sensor located at at least one side of the housing; and a controller configured to operate in at least one of a first mode of recording, in a memory, content corresponding to a motion of the tip or the housing on the basis of an operation of a user, acquired through the motion sensor, and a second mode of performing a specific function on the basis of an operation of the user, and perform mode switching between the first mode and the second mode when the operation of the user acquired through the motion sensor corresponds to a preset operation.

According to another aspect of the present invention, a specific function corresponding to a motion of the tip or the housing may be executed on the basis of the operation of the user acquired through the motion sensor in the second mode.

According to another aspect of the present invention, the motion sensor may include an eye-tracking sensor, wherein the controller performs the mode switching when a preset gaze of the user is sensed through the eye-tracking sensor.

According to another aspect of the present invention, the motion sensor may include at least one of a gyro sensor and an acceleration sensor, wherein the controller performs the mode switching when a preset operation is sensed through at least one of the gyro sensor and the acceleration sensor.

According to another aspect of the present invention, the preset operation may include at least one of a horizontal state, a vertical state, rotation and shaking of the housing.

According to another aspect of the present invention, the motion sensor may include a finger scan sensor located in proximity to the tip, wherein the controller performs the mode switching when a preset user's fingerprint is recognized through the finger scan sensor.

According to another aspect of the present invention, the motion sensor may include a pressure sensor contacting the tip, wherein the controller performs the mode switching on the basis of a user's operation of applying a force to the tip.

According to another aspect of the present invention, content corresponding to a trajectory according to a motion of the tip may be stored in the memory on the basis of the operation of the user acquired through the motion sensor in the first mode.

According to another aspect of the present invention, the specific function of the second mode may activate one of functions in a group including a plurality of functions.

According to another aspect of the present invention, the plurality of functions may include at least one of calling, message transmission/reception, contact display, alarm, playback, recording, and e-mail transmission/reception functions.

According to another aspect of the present invention, the controller may perform the mode switching when the preset operation is maintained for a preset time or longer.

According to another aspect of the present invention, the electronic device may further include a nib combined with the tip and providing ink when contacting other objects.

According to another aspect of the present invention, the electronic device may further include a wireless communication unit configured to transmit/receive content stored in the memory to/from at least one other device.

According to another aspect of the present invention, the housing may have a cylindrical shape,

and the electronic device may further include a display surrounding the outer surface of the housing.

According to another aspect of the present invention, when the user rotates the housing using the direction in which the housing is elongated to extend as a shaft, the controller may scroll content displayed on the display.

According to another aspect of the present invention, the motion sensor may include an optical sensor for measuring a motion or a trajectory of the tip through a laser, wherein the controller stores content corresponding to the motion or trajectory of the tip in the memory.

According to another aspect of the present invention, the electronic device may further include a display provided to the outer surface of the housing, wherein the controller activates the display upon switching to the second mode.

According to another aspect of the present invention, the electronic device may further include: a pin fixed to one side of the housing; and a display provided to the front side of the pin.

According to another aspect of the present invention, the electronic device may further include a switch provided to the outer surface of the housing, wherein the controller performs the mode switching when the user operates the switch.

According to another aspect of the present invention, the housing may have a triangular cross section, the motion sensor may include at least one of a gyro sensor, an acceleration sensor and an angular acceleration sensor, and the electronic device may further include a plurality of displays provided to the outer surface of the housing, wherein the controller activates at least one of the plurality of displays depending on a user's housing gripping state acquired through the motion sensor.

### Advantageous Effects

The electronic device according to the present invention has the following advantages.

According to at least one embodiment of the present invention, it is possible to provide an electronic device capable of recording motion.

According to at least one embodiment of the present invention, it is possible to provide an electronic device capable of being controlled according to motion.

According to at least one embodiment of the present invention, it is possible to provide an electronic device capable of switching modes according to a specific operation.

According to at least one embodiment of the present invention, it is possible to provide an electronic device capable of switching modes according to a switch.

According to at least one embodiment of the present invention, it is possible to provide an electronic device capable of extending a display.

According to at least one embodiment of the present invention, it is possible to provide an electronic device including a roll type display.

The above and other aspects of the present invention will be described in detail through preferred embodiments with reference to the accompanying drawings so that the present invention can be easily understood and realized by those skilled in the art. Modifications to the preferred embodiment will be readily apparent to those of ordinary skill in the art, and the disclosure set forth herein may be applied to other embodiments and applications without departing from the spirit and scope of the present invention and the appended claims.

### BRIEF DESCRIPTION OF THE DRAWINGS

FIG. 1 illustrates an electronic device according to some embodiments of the present invention.

FIG. 2 illustrates electronic elements of the electronic device according to some embodiments of the present invention.

FIG. 3 illustrates a pin according to some embodiments of the present invention.

FIGS. 4 to 6 illustrate housings according to other embodiments of the present invention.

FIGS. 7 and 8 illustrate tips according to some embodiments of the present invention.

FIG. 9 illustrates an optical sensor according to some embodiments of the present invention.

FIGS. 10 and 11 illustrate modes of the electronic device according to some embodiments of the present invention.

FIG. 12 illustrates an electronic device tip according to other embodiments of the present invention.

FIGS. 13 and 14 illustrate operations of the electronic device according to some embodiments of the present invention.

FIG. 15 is a block diagram for describing an electronic device related to the present invention.

FIG. 16 is a flowchart illustrating an operation of the electronic device according to some embodiments of the present invention.

FIG. 17 is a flowchart illustrating a first mode operation of the electronic device according to some embodiments of the present invention in detail.

FIG. 18 is a flowchart illustrating a second mode operation of the electronic device according to some embodiments of the present invention in detail.

FIG. 19 illustrates operation modes of the electronic device of FIG. 16.

FIGS. 20 and 21 illustrate an operation of the electronic device according to some embodiments of the present invention.

FIGS. 22 to 28 illustrate another example of the operation of the electronic device according to some embodiments of the present invention.

FIGS. 29 and 30 illustrate an example of a switch according to some embodiments of the present invention.

FIGS. 31 to 39 illustrate other examples of a switch according to some embodiments of the present invention.

FIG. 40 illustrates an example of a display according to some embodiments of the present invention.

FIGS. 41 and 42 illustrate other examples of the display according to some embodiments of the present invention.

FIG. 43 illustrates an example of the cross section of the display according to some embodiments of the present invention.

FIGS. 44 to 46 illustrate another example of the display according to some embodiments of the present invention.

FIGS. 47 and 48 illustrate an example of the electronic device according to some embodiments of the present invention.

FIG. 49 is an exploded diagram of the display according to some embodiments of the present invention.

FIG. 50 illustrates an example of the inside of a housing according to some embodiments of the present invention.

FIGS. 51 to 59 illustrate other examples of operation of the electronic device according to some embodiments of the present invention.

### DESCRIPTION OF EXEMPLARY EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” or “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected to” another element, the element can be connected with the other element or intervening elements may also be present. In contrast, when an element is referred to as being “directly connected to” another element, there are no intervening elements present.

A singular representation may include a plural representation unless it represents a definitely different meaning from the context.

Terms such as “include” and “has” are used herein and should be understood that they are intended to indicate the existence of several components, functions or steps, disclosed in the specification, and it is also understood that greater or fewer components, functions, or steps may likewise be utilized.

Electronic devices presented herein may be implemented using a variety of different types of terminals. Examples of such terminals include cellular phones, smartphones, user equipment, laptop computers, digital broadcast terminals, personal digital assistants (PDAs), portable multimedia players (PMPs), navigators, portable computers (PCs), slate PCs, tablet PCs, ultra-books, wearable devices (for example, smart watches, smart glasses, head mounted displays (HMDs)), and the like.

By way of non-limiting example only, further description will be made with reference to particular types of electronic devices. However, such teachings apply equally to other types of terminals, such as those types noted above. In addition, these teachings may also be applied to stationary terminals such as digital TVs, desktop computers, digital signage and the like.

A description will be given of embodiments related to a control method which can be implemented in the aforementioned electronic devices with reference to the attached drawings. Those skilled in the art will appreciate that the present invention may be carried out in other specific ways than those set forth herein without departing from the spirit and essential characteristics of the present invention.

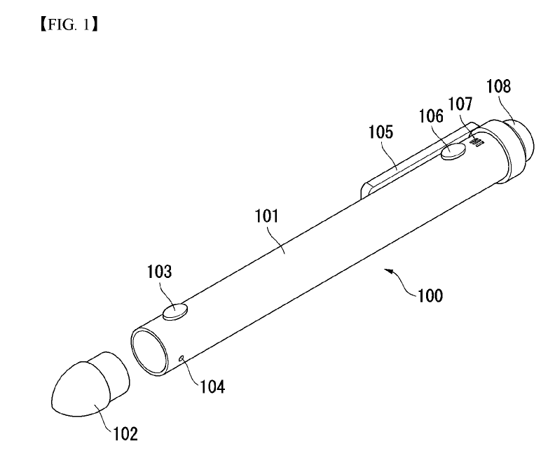

It should be understood that implementing all of the components illustrated in FIGS. 1 to 15 is not a requirement, and that greater or fewer components may alternatively be implemented.

FIG. 1 illustrates an electronic device according to some embodiments of the present invention.

An electronic device 100 may include a housing 101, a tip 102, a sensor 103, a microphone 104, a clip 105, a sensor 106, a speaker 107 and a cap 108. More specifically, the housing 101 may take an elongated shape. The housing 101 may be for gripping convenience of a user. For example, the housing 101 may have an elongated cylinder shape.

One end of the tip 102 may be sharp. The other end of the tip 102 may be combined with one end of the housing 101. The tip 102 may be combined with one end of the housing 102 such that the user can grip the housing 102 and write with the tip 102. The tip 102 may be made of a flexible material or a rigid material. The tip 102 may include a pressure sensor 149 therein, which will be described later.

The sensors 103 and 106 may be provided to the outer face of the housing 101. The sensors 103 and 106 may include a sensor for sensing whether the user grips the housing, a sensor for recognizing a fingerprint of the user, a sensor for recognizing a retina of the user and a camera module including an image sensor. In addition, the sensors may be provided on buttons. The user can push the sensors with a finger to execute functions assigned thereto. A sensor may be configured to execute a function of an input device of another electronic device such as a mouse by using the aforementioned pressure sensor of the tip 102 and a button. Functions of sensors can be configured in various manners as necessary.

The microphone may be included in the housing 101 and a microphone hole 104 may be formed in the housing 101. The speaker may be included in the housing 101 and a speaker hole 107 may be formed in the housing 101. A recording function, a multimedia function, a voice transmission/reception function, and the like can be implemented according to a selective or integrated configuration of the microphone and the speaker.

The clip 105 may be combined with one side of the housing 101 or integrated with the housing 101. The cap 108 may be combined with the end of the housing 101 opposite the side combined with the top 102. The cap 108 may be a cover of an opening of the housing 101 or a button and may include a pressure sensor. The function of the cap 108 may be configured in various manners as necessary.

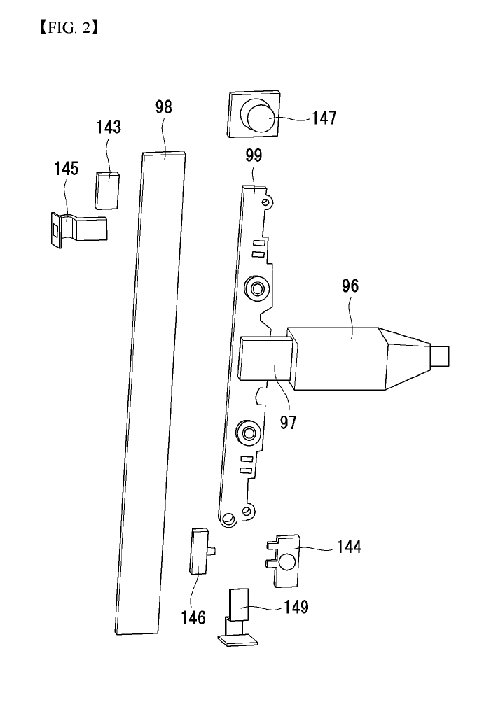

FIG. 2 illustrates electronic elements of the electronic device according to some embodiments of the present invention. The electronic elements may include a PCB 99, a gyro sensor 143, an acceleration sensor 144, an angular acceleration sensor 145, a finger scan sensor 146, an eye-tracking sensor 147, and a pressure sensor 149.

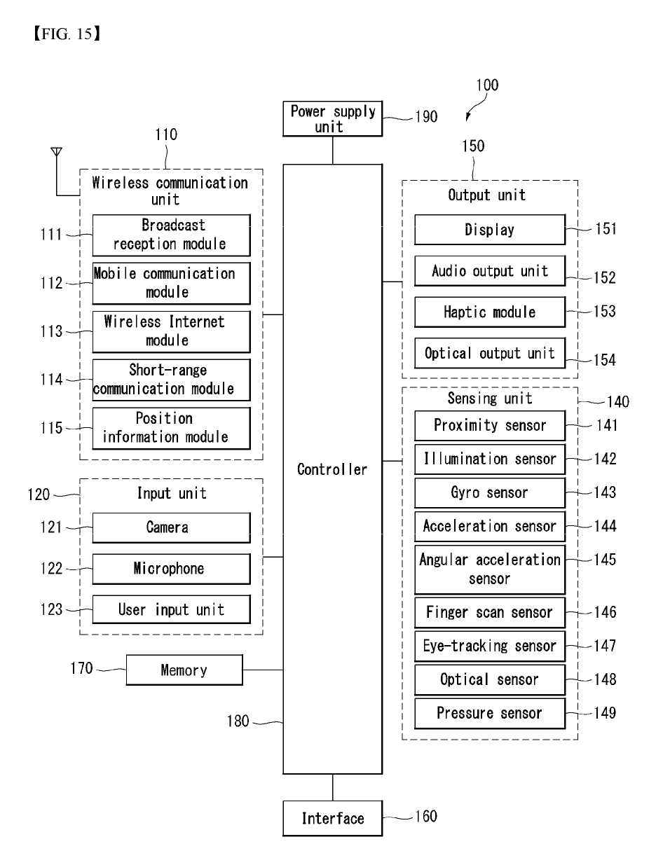

More specifically, components of the electronic device which will be described with reference to FIG. 15 may be mounted on the PCB 99 or an FPCB 98. A connector 97 may be mounted on the PCB 99. The connector 97 can be electrically connected to an external terminal 96. The connector 97 and the external terminal 96 may be data transfer lines or wires for supplying power.

The gyro sensor 143 may be an element which measures repulsive power generated when an object including a gyroscope rotates and converts the repulsive power into an electrical signal. The gyro sensor measures motion of an object in an inertial coordinate system to sense a moving distance and direction and can recognize a path of the object in three-dimensional space. For example, the gyro sensor 143 may be a MEMS gyro sensor.

The acceleration sensor 144 can sense intensity of acceleration or impact of a moving object. The acceleration sensor 144 measures motion of an object in the inertial coordinate system and can recognize a path of the object. For example, the acceleration sensor 144 may be a MEMS acceleration sensor.

For example, if an object moves in two dimensions, one gyro sensor 143 and two acceleration sensors 144 are needed. If an object moves in three dimensions, as another example, three gyro sensors 143 and three acceleration sensors 144 are needed.

The angular acceleration sensor 145 may be a gyro sensor which senses rotational motion of an object in the inertial coordinate system. The angular acceleration sensor 145 may be integrated with the gyro sensor 143 and the acceleration sensor 144 to improve sensor sensitivity.

The finger scan sensor 146 can recognize a user by acquiring a digital image of a fingerprint of the user. For example, optical, ultrasonic, and capacitive finger scan sensors may be used.

The eye-tracking sensor 147 can sense a user's eye and recognize the position of a user's gaze by tracking motion of a retina. The pressure sensor 149 can convert a force applied thereto into an electrical signal to measure the magnitude of the force.

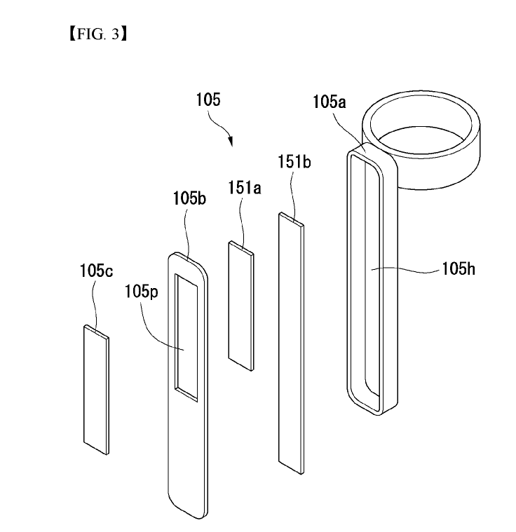

FIG. 3 illustrates a pin according to some embodiments of the present invention. The pin 105 may include a holder 105a, a display module 151, a cover 105b and a window 105c.

The holder 105a may be combined with one side of the housing 101 in such a manner that one side of the housing 101 is inserted into the holder 105a or may be integrated with the housing 101. The holder 105a may elastically move with respect to the housing 101. The holder 105a may include a groove 105h in which the display module 151 is mounted.

The display module 151 may include a PCB 151b and a display panel 151a. The PCB 151b may have electronic elements for controlling the display panel 151a mounted thereon. The display panel 151a may be electrically connected to the PCB 151b to display predetermined information. The display module 151 may be a flexible display adapted to elastic motion of the holder 105a.

The cover 105b may be combined with the holder 105a to fix the display module 151 when the display module 151 is mounted in the groove 105h of the holder 105a. The cover 105b may have an opening 105p at a position corresponding to the display module 151. The window 105c may be combined with the opening 105p to protect the display. The window 105c may include a touch window for the purpose of input in addition to display protection.

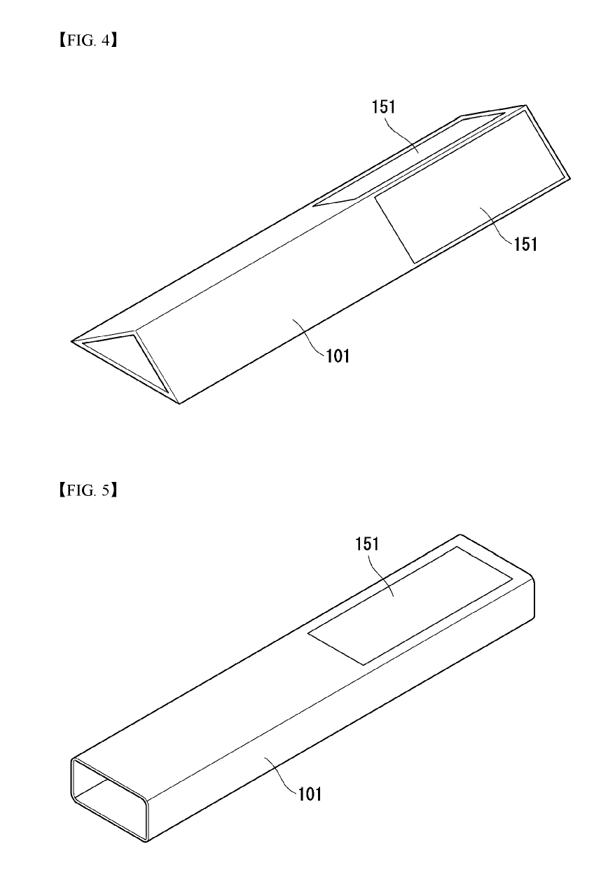

FIG. 4 illustrates a housing according to other embodiments of the present invention.

The housing 101 may be elongated and have a triangular cross section. When the housing 101 has a triangular cross section, gripping convenience of the user can be improved and rolling of the electronic device 100 can be prevented. The display 151 may be provided to the outer face of the housing 101. Here, a plurality of displays 151 may be provided. For example, a plurality of displays 151 may be respectively provided to outer faces of the housing 101 having the triangular cross sections. There may be a display 151 that the user can see and a display 151 that the user cannot see when the user grips the housing 101 having the triangular cross section. Here, at least one of the gyro sensor 143, the acceleration sensor and the angular acceleration sensor 145 can detect a grip state of the user. In addition, the display 151 that the user is looking at can be activated. The display 151 that the user cannot see can enter a power-saving mode. The components described with reference to FIGS. 1 to 3 can be included in the housing.

FIG. 5 illustrates a housing according to other embodiments of the present invention.

The housing 101 may be elongated and have a rectangular cross section. When the housing 101 has a rectangular cross section, the area (which can include the area of the display) of one face of the housing 101 can be widened and rolling of the electronic device 100 can be prevented. The display 151 may be provided to a wider outer face of the housing 101. The components described with reference to FIGS. 1 to 3 can be included in the housing.

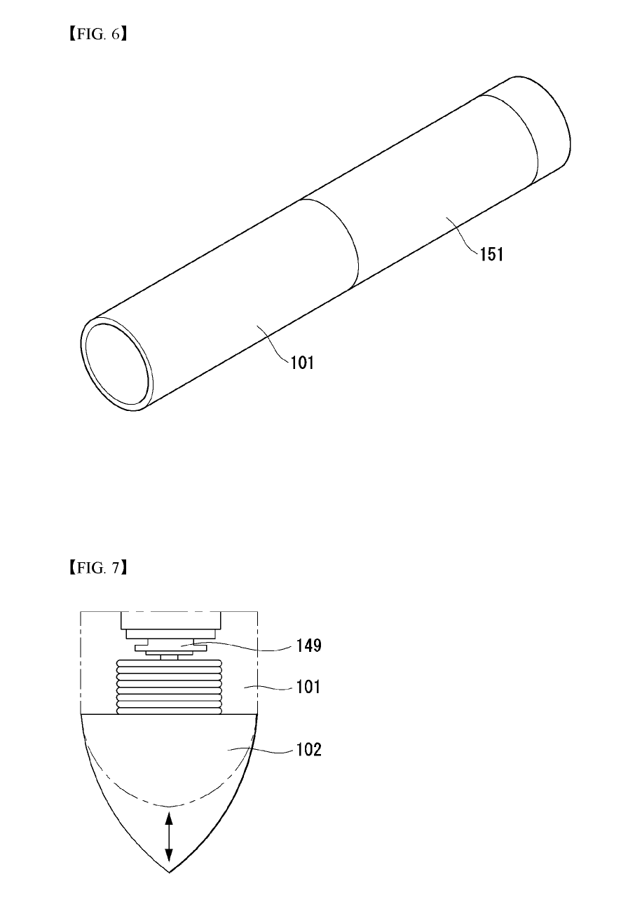

FIG. 6 illustrates a housing according to other embodiments of the present invention.

The housing 101 may be elongated and have a circular cross section. When the housing 101 has a circular cross section, user convenience can be provided such that the user does not consider directivity of the housing 101. The display 151 may be provided to surround at least part of the outer surface of the housing 101. Accordingly, a display with a wider area can be provided. Furthermore, a display with an infinite area may be provided in such a manner that information displayed on the display is scrolled as the cylindrical display rotates. The components described with reference to FIGS. 1 to 3 can be included in the housing.

FIG. 7 illustrates a tip according to some embodiments of the present invention.

One side of the tip 102 is combined with the housing 101 and the other side may have a narrower cross section than the one side thereof. This means that the tip 102 tapers from the housing 101. The end of the tip 102 may be rounded. The tip 102 may be made of an elastic material. The tip 102 may be made of a rigid material. A predetermined displacement or deformation may occur in the tip 102 according to force applied thereto. Such displacement or deformation may be sensed by the pressure sensor 149. The pressure sensor 149 may be mounted inside of the housing 101 to contact one end of the tip 102.

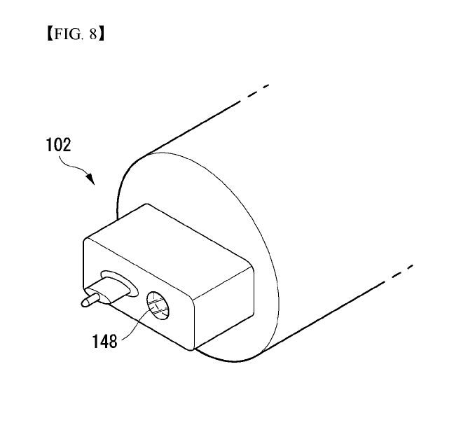

FIG. 8 illustrates a tip according to other embodiments of the present invention.

The tip 102 may be formed as multi-stage protrusions. An optical sensor 148 may be provided to one side of the tip 102. The optical sensor 148 can sense a motion (or trajectory) of the tip. The optical sensor 148 can emit a laser to the tip and measure the laser reflected from the surface of the tip to track a motion of the tip 102. Accordingly, the electronic device is not limited to write on any surface or any attributes of writing area.

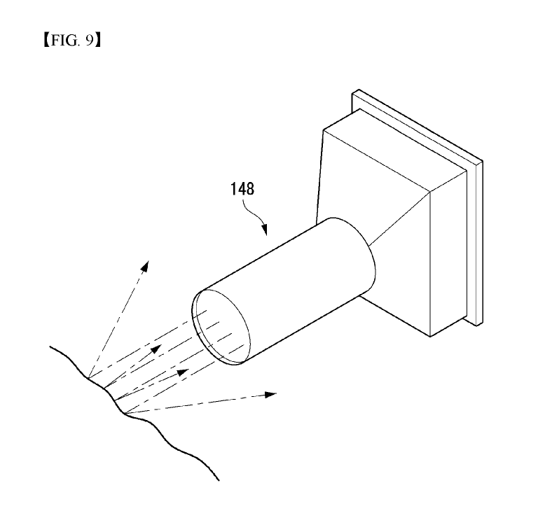

FIG. 9 illustrates an optical sensor according to some embodiments of the present invention.

The optical sensor 148 can emit a laser. The emitted laser can be reflected from a writing surface. Some light may be deviated from the range of the optical sensor 148 and some light may be measured within the range of the optical sensor 148 depending on the writing surface. For example, the optical sensor 148 can have specifications of a resolution of 2000 dpi, a motion velocity of 0 to 1000 mm/sec, optical power of 0.3 mW and a wavelength of 850 nm.

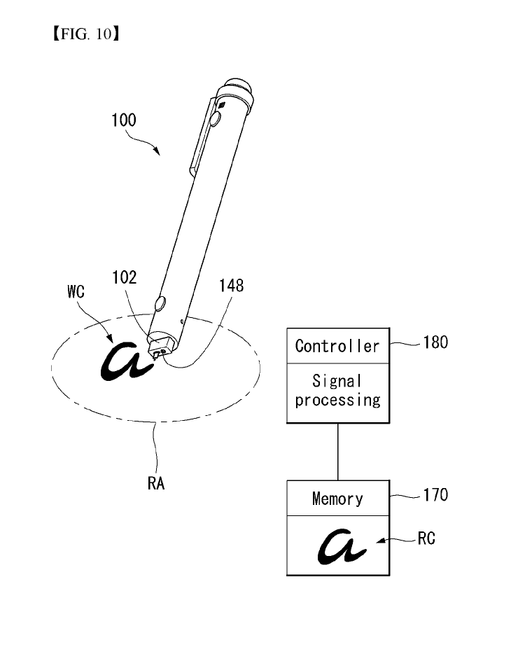

FIG. 10 illustrates an electronic device mode according to some embodiments of the present invention.

The electronic device mode illustrated in FIG. 10 may be a writing mode. When the user grips the electronic device 100 and writes, the tip 102 is moved (or follows a trajectory) according to user's intention and the optical sensor 148 measures such motion or trajectory and transmits a signal corresponding to the measurement result to a controller 180. The controller 180 may process the signal transmitted from the optical sensor 148 and store the processed signal in a memory 170. For example, when the user writes (RA) a character WC corresponding to the letter “a”, the optical sensor 148 measures the motion of the tip 102 and the controller 180 can process a signal output from the optical sensor 148 and store information RC of character “a” in the memory 170.

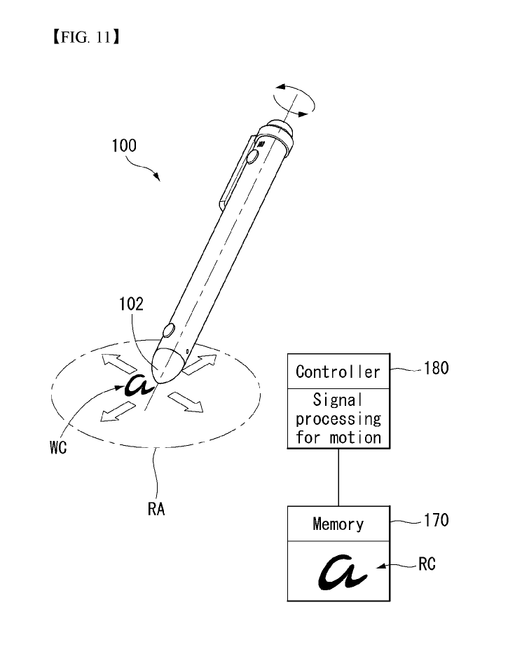

FIG. 11 illustrates an electronic device mode according to other embodiments of the present invention.

The electronic device mode illustrated in FIG. 11 may be a writing mode. When the user grips the electronic device 100 and writes, the tip 102 is moved (or follows a trajectory) according to user's intention and a sensor module measures such motion or trajectory and transmits a signal corresponding to the measurement result to the controller 180. The sensor module may include the gyro sensor 143, the acceleration sensor 144 or the angular acceleration sensor 145. The position of the sensor module may be close to the tip 102 or separated from the tip 102. The position of the sensor module is not limited as long as measurement sensitivity is secured. The controller 180 can process the signal transmitted from the sensor module and store the processed signal in the memory 170. For example, when the user writes a character WC corresponding to the letter “a”, the sensor module measures the motion of the tip 102 and the controller 180 can process a signal output from the sensor module and store information RC of character “a” in the memory 170. Here, the sensor module may measure a motion or a trajectory of the housing 101 and transmit a signal corresponding to the measurement result to the controller 180.

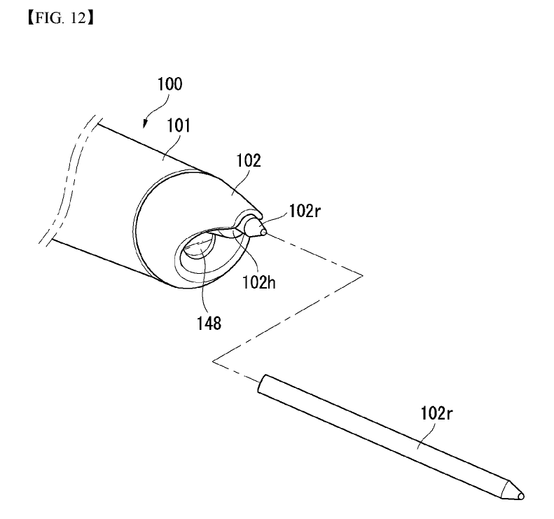

FIG. 12 illustrates a tip of the electronic device according to other embodiments of the present invention.

The electronic device 100 may include a nib 102r. The nib 102r may be refill ink for ballpoint pens, a water-based or oil-based pen, a lead, electronic ink, or the like. The tip 102 may include a fastening hole 102h for combining the nib 102r therewith. The fastening hole 102h may be formed in the tip 102 or formed in the tip 102 and the housing 101. The optical sensor 148 may be positioned near the nib 102r. Accordingly, the user can write a note, and the note can be digitalized and stored. For example, when the user attends a lecture, the user can write the contents of the lecture and the written contents can be stored as digital text. In addition, the written contents may be transmitted to another electronic device simultaneously with writing. When the user delivers a lecture as another example, the user can write the contents of the lecture simultaneously with lecture and the written contents can be stored as digital text and transmitted to attendees. Accordingly, users can concentrate on the lecture without the need to write down the contents of the lecture.

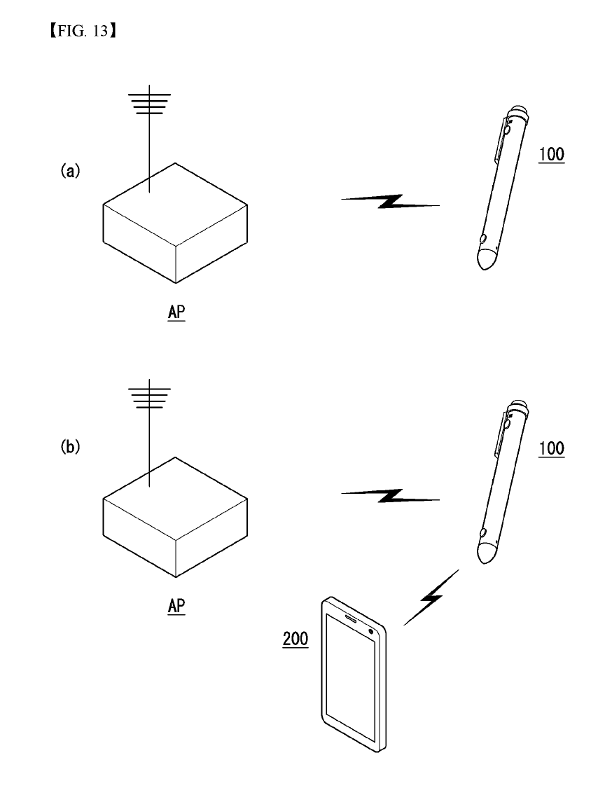

FIG. 13 illustrates an operation of the electronic device according to some embodiments of the present invention.

As shown, the electronic device 100 according to an embodiment of the present invention may perform a communication function.

As illustrated in FIG. 13(a), the electronic device 100 can directly communicate with an access point (AP). For example, the electronic device 100 can transmit data to the AP using a wireless antenna embedded therein and receive data from the AP. This feature differs from conventional devices subordinate to another terminal owned by a user.

As illustrated in FIG. 13(b), the electronic device 100 communicating with the AP can transmit data to another electronic device 200. For example, the electronic device 100 can relay data to the electronic device 200 paired therewith.

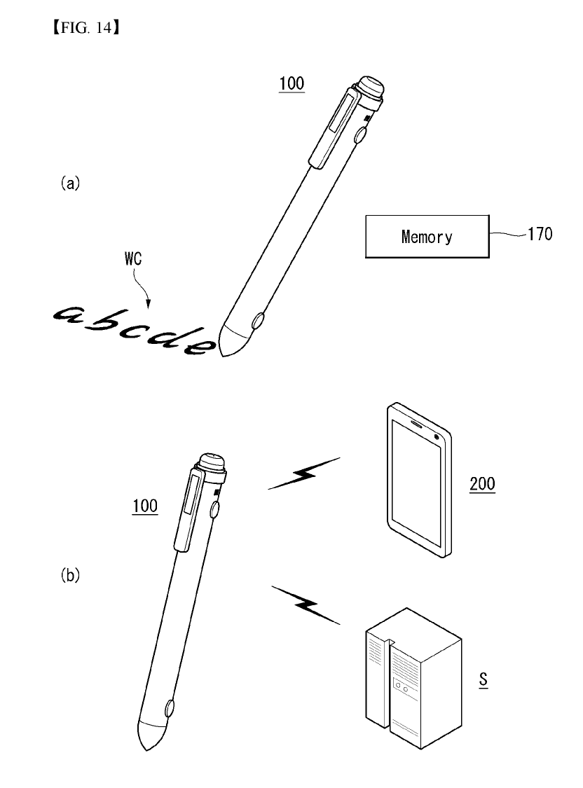

FIG. 14 illustrates an operation of the electronic device according to some embodiments of the present invention.

As shown, the electronic device 100 according to an embodiment of the present invention can store and/or transmit content WC in various manners.

As illustrated in FIG. 14(a), the user can generate the content WC using the electronic device 100. For example, the user can write letters using the electronic device 100 in the form of a pen. The electronic device 100 can recognize the letters which is the content WC generated by the user using an optical sensor and/or an acceleration sensor.

The electronic device 100 may store the content WC generated by the user in a text format and/or an image format in the memory 170 included in the electronic device 100. That is, the controller 180 of the electronic device 100 can recognize the content WC generated by the user and store the content WC in the text format such that the entire storage capacity does not increase. When the content WC cannot be easily recognized or the content WC is a picture, the controller 180 may store the content WC in the image format.

As illustrated in FIG. 14(b), the controller 180 may synchronize the electronic device 100 with another device 200. During synchronization with the other device 200, the controller 180 may transmit the content WC stored in the memory 170. Synchronization with the other device 200 can be performed when the electronic device 100 is in an idle state.

The controller 180 may synchronize the content WC stored in the memory 170 with an external server S and transmit the content WC to the external server S.

The controller 180 may delete the content WC synchronized with the other device 200 and/or the external server S from the memory 170. That is, the controller 180 can delete synchronized data in order to free up space of the memory 170.

FIG. 15 is a block diagram for describing the electronic device related to the present invention.

The electronic device 100 may include a wireless communication unit 110, an input unit 120, a sensing unit 140, an output unit 150, an interface 160, the memory 170, the controller 180 and a power supply unit 190. The components illustrated in FIG. 15 are not essential for implementing the electronic device and thus the electronic device described in the specification may have greater or fewer components.

More specifically, the wireless communication unit 110 among the aforementioned components may include one or more modules which enable wireless communication between the electronic device 100 and a wireless communication system, between the electronic device 100 and another electronic device or between the electronic device 100 and an external device. In addition, the wireless communication unit 110 may include one or more modules which connect the electronic device 100 to one or more networks.

The wireless communication unit 110 may include at least one of a broadcast reception module 111, a mobile communication module 112, a wireless Internet module 113, a short-range communication module 114 and a position information module 115.

The input unit 120 may include a camera 121 or an image input unit for image signal input, a microphone 122 or an audio input unit for audio signal input, and a user input unit 123 (e.g., a touch key, a mechanical key, etc.) through which a user inputs information. Audio data or image data collected by the input unit 120 may be analyzed and processed into a control command of the user.

The sensing unit 140 may include one or more sensors for sensing at least one of information in the electronic device, information on surrounding environments of the electronic device and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., the camera 121), the microphone 122, a battery gauge, environment sensors (e.g., a barometer, a hygrometer, a thermometer, a radioactive sensor, a heat sensor, a gas sensor, etc.), the gyro sensor 143, the acceleration sensor 144, the angular acceleration sensor 145, the finger scan sensor 146, the eye-tracking sensor 147 and the operation sensor 148 which have been described with reference to FIG. 2. The electronic device disclosed in the specification can combine information sensed by at least two of these sensors and use the same.

The output unit 150 generates visual, auditory or tactile output and may include at least one of a display unit 151, an audio output unit 152, a haptic module 153 and an optical output unit 154. The display unit 151 may implement a touchscreen by forming a layered structure with a touch sensor or by being integrated with the touch sensor. Such a touchscreen can serve as the user input unit which provides an input interface between the electronic device 100 and the user and, simultaneously, provide an output interface between the electronic device 100 and the user.

The interface 160 serves as a path to various external devices connected to the electronic device 100. The interface 160 may include at least one of a wired/wireless headset port, an external charger port, a wired/wireless data port, a memory card port, a port for connecting a device including an identification module, an audio input/output (I/O) port, a video I/O port and an earphone port. The electronic device 100 can perform appropriate control related to an external device connected thereto in response to connection of the external device to the interface 160.

The memory 170 stores data supporting various functions of the electronic device 100. The memory 170 can store various application programs (or applications) executed in the electronic device 100, data and commands for operation of the electronic device 100. At least part of such application programs can be downloaded from an external server through wireless communication. In addition, at least part of such application programs may have been installed in the electronic device 100 when the electronic device 100 is delivered for basic functions (e.g., call sending and receiving function, message sending and receiving functions) of the electronic device 100. The application programs may be stored in the memory 170 and installed in the electronic device 100 such that the application programs can be executed by the controller 180 to perform operations (or functions) of the electronic device.

The controller 180 controls the overall operation of the electronic device 100 in addition to operations related to the application programs. The controller 180 can process signals, data, information and the like input or output through the aforementioned components and execute the application programs stored in the memory 170 to provide or process information or functions suitable for the user.

In addition, the controller 180 may control at least part of the components described with reference to FIG. 15 in order to execute the application programs stored in the memory 170. Furthermore, the controller 180 may combine at least two of the components included in the electronic device 100 and operate the same in order to execute the application programs.

The power supply unit 190 is provided with external power and internal power under the control of the controller 180 and supplies power to each component included in the electronic device 100. The power supply unit 190 includes a battery and the battery may be an embedded battery or a replaceable battery.

At least parts of the aforementioned components may cooperatively operate in order to implement operations, control or control methods of the electronic device according to various embodiments which will be described below. In addition, the operations, control or control methods of the electronic device may be implemented in the electronic device according to execution of at least one of the application programs stored in the memory 170.

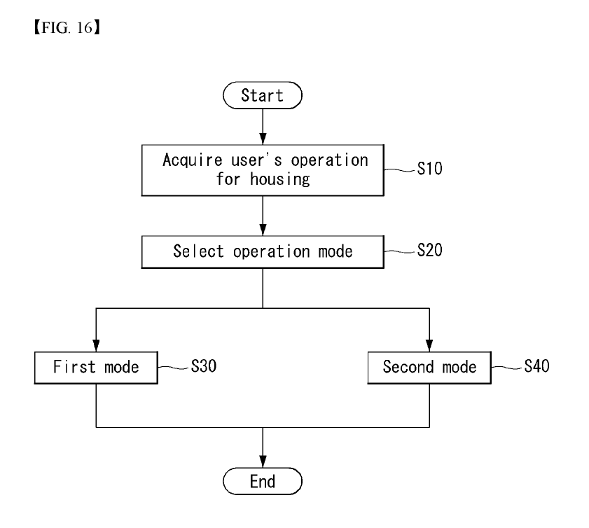

FIGS. 16 to 18 are flowcharts illustrating operations of the electronic device according to some embodiments of the present invention.

As shown, the controller 180 of the electronic device 100 according to some embodiments of the present invention can operate in different operation modes on the basis of the intentions of the user.

As illustrated in FIG. 16, the controller 180 may perform step S10 of acquiring user manipulation applied to the housing 101 or the tip 102.

The controller 180 may acquire user manipulation applied to the housing 101 or the tip 102 through the sensing unit 140. For example, the controller 180 can recognize a mode that the user wants to enter when the user performs a predetermined operation while gripping the housing 101.

The sensing unit 140 may be a combination of at least one of the optical sensor 148, the gyro sensor 143, the acceleration sensor 144 and the angular acceleration sensor 145.

The controller 180 may perform step S20 of selecting an operation mode according to user manipulation. Operation modes may include a first mode S30 and a second mode S40.

The first mode may be a mode in which content corresponding to a trajectory according to a motion of the housing 101 or the tip 102 is stored in the memory 170. That is, the first mode may correspond to a case in which the user who grips the electronic device 100 according to some embodiments of the present invention performs a recording operation. In the first mode, the controller 180 may acquire handwriting input by the user using the sensing unit 140. The acquired handwriting may be stored in a text format in the memory 170. The acquired handwriting may be stored in an image format in the memory 170. Storage in the text format can be more advantageous than storage in the image format in terms of storage capacity.

The second mode may be a mode in which a function corresponding to a motion of the housing 101 is executed. For example, the controller 180 can recognize a motion corresponding to user manipulation applied to the electronic device 100 as an instruction for controlling operation of the electronic device 100 in the second mode. Motions may include a horizontal state of the housing 101, a vertical stage of the housing 101, rotation of the housing 101, rolling of the housing 101, dropping of the housing 101, switching, eyes of a user staring at the housing 101 or the display 151, a fingerprint of a user derived from the operation of gripping the housing 101, application of a force to the tip 102, etc. Manipulation of the display 151 can also be included in motions.

In the second mode, a user of the electronic device 100 may not perform manipulation on the electronic device 100 in order to perform various operations using the electronic device 100. For example, the user can activate or deactivate necessary functions without operating buttons or the like provided to the electronic device 100.

FIG. 17 is a flowchart illustrating the first mode operation of the electronic device according to some embodiments of the present invention in detail.

In the first mode, the controller 180 may perform step S31 of acquiring a trajectory of the housing 101. More specifically, the trajectory of the housing 101 may refer to a trajectory of the tip 102 provided to one end of the housing 101.

The controller 180 may perform step S33 of generating content corresponding to the trajectory. For example, the controller 180 can recognize content such as characters, numerals, a picture and the like input by the user using the electronic device 100. The controller 180 can extract characters through a signal processing procedure when user input is acquired through the optical sensor 148. The extracted characters can be converted into text.

The controller 180 may perform step S35 of storing the generated content. The content can be stored in the memory 170 of the electronic device 100. When the content is text, storage space can be saved.

The controller 180 may perform step S37 of transmitting the stored content to another device. The electronic device 100 according to some embodiments of the present invention may execute communication functions such as call sending and reception and message sensing and reception. The controller 180 may transmit content stored in the memory 170 to another device of the user. For example, the controller 180 can transmit the content to a device having a larger display. Accordingly, the user can view the content more conveniently.

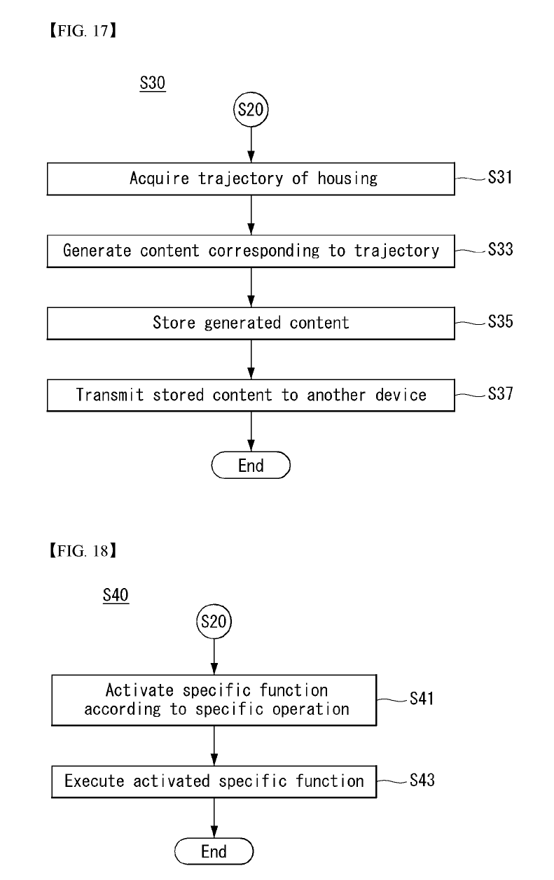

FIG. 18 is a flowchart illustrating the second mode operation of the electronic device according to some embodiments of the present invention in detail.

In the second mode, the controller 180 may perform step S41 of activating a specific function according to a specific operation of the user.

The user may perform a specific operation using the electronic device 100 gripped thereby. The specific operation may be a command for activating or deactivating a specific function. For example, when the user grips and shakes the electronic device 100 up and down, this operation can be regarded as an intention to use a specific function of executing a call function. A specific operation may be maintaining horizontal state, maintaining vertical state, rotating, shaking, dropping, gazing, switching, fingerprint identification, or the like.

The controller 180 may perform step S43 of executing the activated specific function. For example, when a specific operation for executing the call function is applied as described above, the controller 180 can execute a function of calling using a searched or input telephone number.

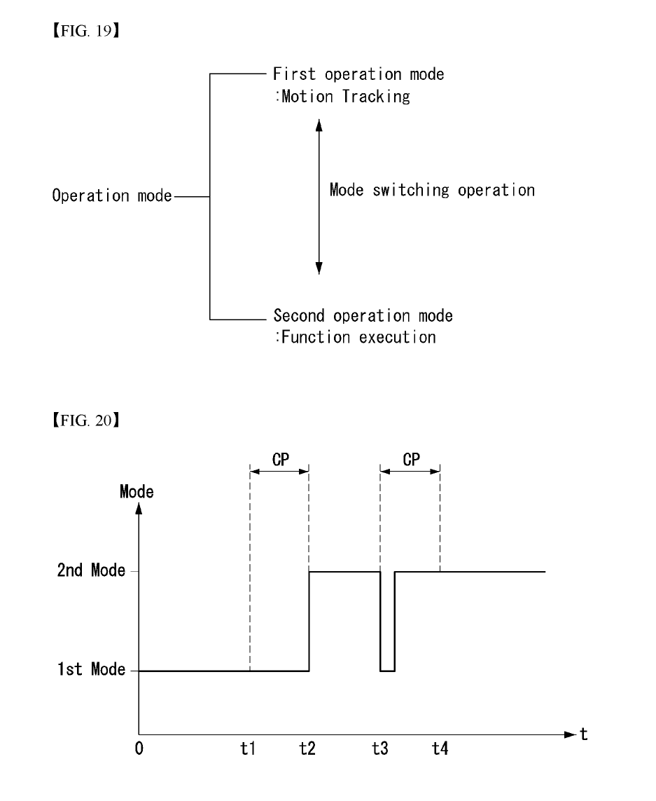

FIG. 19 illustrates operation modes of the electronic device shown in FIG. 16.

As shown, operation modes may include a first operation mode and a second operation mode. Motion tracking can be performed in the first operation mode and functions can be executed in the second operation mode.

In the first operation mode, the controller 180 can store a motion tracking result as content.

In the second operation mode, the controller 180 can execute a specific function corresponding to user input. That is, the controller 180 does not store user input as content.

Switching from the first mode to the second mode or switching from the second mode to the first mode may be performed according to a predetermined user operation. The predetermined user operation may be maintaining horizontal state, maintaining vertical state, rotating, shaking, dropping, gazing of the user, user fingerprint identification, switching, or the like.

For example, when the predetermined operation is maintaining horizontal state, the controller 180 can switch from the first mode to the second mode or switch from the second mode to the first mode when the user maintains the electronic device 100 in a horizontal state for a predetermined time.

As another example, when the predetermined operation is maintaining vertical state, the controller 180 can switch from the first mode to the second mode or switch from the second mode to the first mode when the user maintains the electronic device 100 in a vertical state for a predetermined time.

As another example, when the predetermined operation is rotating, the controller 180 can switch from the first mode to the second mode or switch from the second mode to the first mode when the user rotates the electronic device 100 for a predetermined time.

As another example, when the predetermined operation is shaking, the controller 180 can switch from the first mode to the second mode or switch from the second mode to the first mode when the user shakes the electronic device 100 for a predetermined time.

As another example, when the predetermined operation is dropping, the controller 180 can switch from the first mode to the second mode or switch from the second mode to the first mode when the user drops the electronic device 100.

As another example, when the predetermined operation is gazing of the user, the controller 180 can switch from the first mode to the second mode or switch from the second mode to the first mode when the user gazes at the electronic device 100 for a predetermined time. The destination of the gaze may be the housing 101, the display 151 or the eye-tracking sensor 147.

As another example, when the predetermined operation is switching, the controller 180 can switch from the first mode to the second mode or switch from the second mode to the first mode when the user operates a switch included in the electronic device 100.

As another example, when the predetermined operation is fingerprint identification, the controller 180 can switch from the second mode to the first mode when the user grips the housing 101 of the electronic device 100 and then grips the area around the tip 102 for handwriting. Conversely, the controller 180 can switch from the first mode to the second mode when the user grips the area around the tip 102 and then grips the housing 101 and thus fingerprint identification is released. The finger scan sensor 146 can be provided near the tip 102.

As another example, when the predetermined operation is applying a force to the tip 102, if the user grips the housing 101 of the electronic device 100 and applies a force to the tip 102, the pressure sensor 149 senses the force and the controller 180 can switch from the first mode to the second mode or switch from the second mode to the first mode.

FIG. 20 illustrates operation of the electronic device according to some embodiments of the present invention.

As illustrated in FIG. 20, an operation, posture and/or gesture of a user for mode switching from the first operation mode to the second operation mode or from the second operation mode to the first operation mode can be meaningful when continued for a predetermined time or longer. For example, when the user performs an operation for entering the second operation mode for a critical time CP or longer at time t1, the controller 180 can switch from the first operation mode to the second operation mode.

When the user changes postures within the critical time CP from t3 to t4 during operation in the second operation mode, the controller 180 may not switch operation modes irrespective of posture change. That is, the controller 180 can prevent operation mode switching when careless operation is performed for a moment.

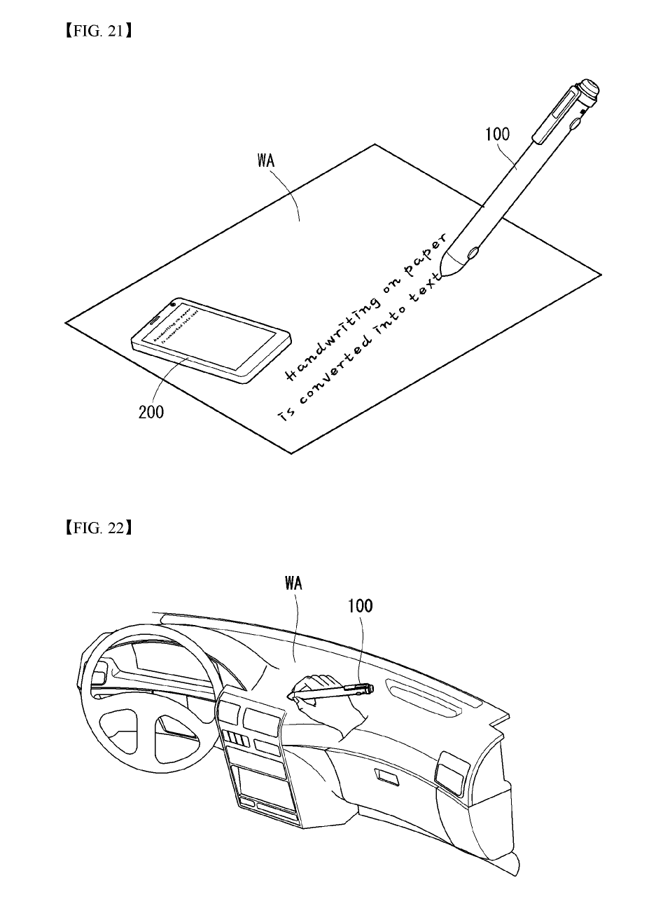

FIG. 21 illustrates an operation of the electronic device according to some embodiments of the present invention.

A user can write in a notebook WA using the electronic device 100. The contents of handwriting of the user may be stored in the electronic device 100 and the stored contents may be transmitted to another electronic device 200. For example, the user may select the electronic device 100 equipped with a ballpoint. When the user writes down in the notebook WA using the selected electronic device 100, the written contents can be visualized through the ballpoint. In addition, the sensor module 140 (e.g., optical sensor or gyro/acceleration/angular acceleration sensor) of the electronic device 100 can sense a motion of the tip 102 or the housing 101 and transmit a signal corresponding to the contents to the controller 180. The controller 180 can process the signal to store the written contents in the memory 170. The wireless communication unit 110 may transmit the stored contents to the other electronic device 200, for example, a mobile terminal, and the other electronic device 200 can display the contents in real time.

Accordingly, the user can record desired contents and visualize the record.

FIG. 22 illustrates another example of operation of the electronic device according to some embodiments of the present invention.

The user can handwrite in an arbitrary writing area WA using the electronic device 100. For example, the arbitrary writing area WA may be a dashboard of a vehicle. The writing of the user can be stored in the electronic device 100. For example, the user can select the electronic device 100 including the tip 102 described above with reference to FIG. 8. When the user writes in the writing area WA using the selected electronic device 100, the handwriting can be recorded through the tip 102 and the optical sensor 148 which measures a motion or trajectory of the tip 102.

The sensor motor 140 (e.g., optical sensor, gyro sensor, acceleration sensor and angular acceleration sensor) of the electronic device 100 can sense a motion of the tip 102 or the housing 101 and transmit a signal corresponding to the handwriting to the controller 180. The controller 180 can process the signal to store the handwriting in the memory 170.

Accordingly, the user can freely record what they want without being restricted by a writing area or writing surface.

FIG. 23 illustrates another example of operation of the electronic device according to some embodiments of the present invention.

The user can write in an arbitrary writing area WA using the electronic device 100. For example, the arbitrary writing area WA may be a table. The handwriting of the user can be stored in the electronic device 100. For example, the user can select the electronic device 100 including the tip 102 described above with reference to FIG. 8. When the user writes in the writing area WA using the selected electronic device 100, the handwriting can be recorded through the tip 102 and the optical sensor 148 which measures a motion or trajectory of the tip 102.

The sensor motor 140 (e.g., optical sensor, gyro sensor, acceleration sensor the angular acceleration sensor) of the electronic device 100 can sense a motion of the tip 102 or the housing 101 and transmit a signal corresponding to the handwriting to the controller 180. The controller 180 can process the signal to store the handwriting in the memory 170.

The handwriting of the user can be stored in the electronic device 100 and the stored handwriting can be transmitted to another electronic device 200. The wireless communication unit 110 may transmit the stored handwriting to the other electronic device 200, for example, a mobile terminal, and the other electronic device 200 can display the contents in real time.

The user not only can record desired content and visualize the record but also freely record what they want without being restricted by a writing area or writing surface.

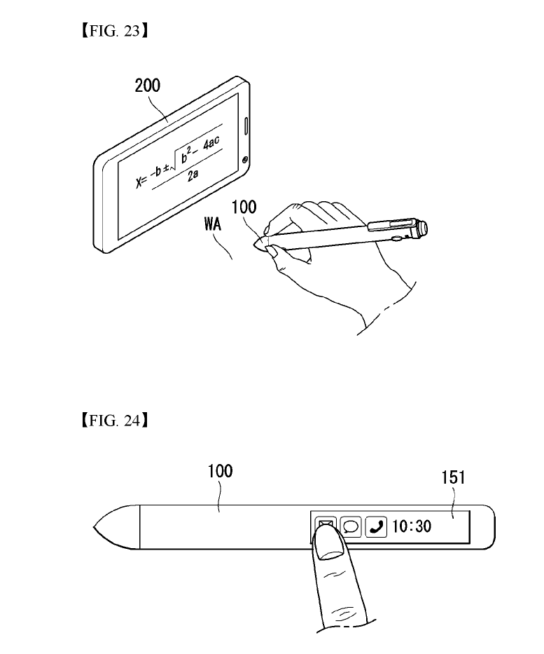

FIG. 24 illustrates another example of operation of the electronic device according to some embodiments of the present invention.

The user can execute functions such as voice call transmission and reception, text transmission and reception, recording and the like using the electronic device 100. These functions can be executed in the aforementioned second mode. The user can select a function by touching the display 151. In addition, the user may select a function through the above-described predetermined operation. For example, if a predetermined operation for voice call transmission and reception is shaking, the user can enter a voice communication mode by shaking the electronic device 100. That is, transmission and reception of a voice call can be performed by shaking the electronic device 100.

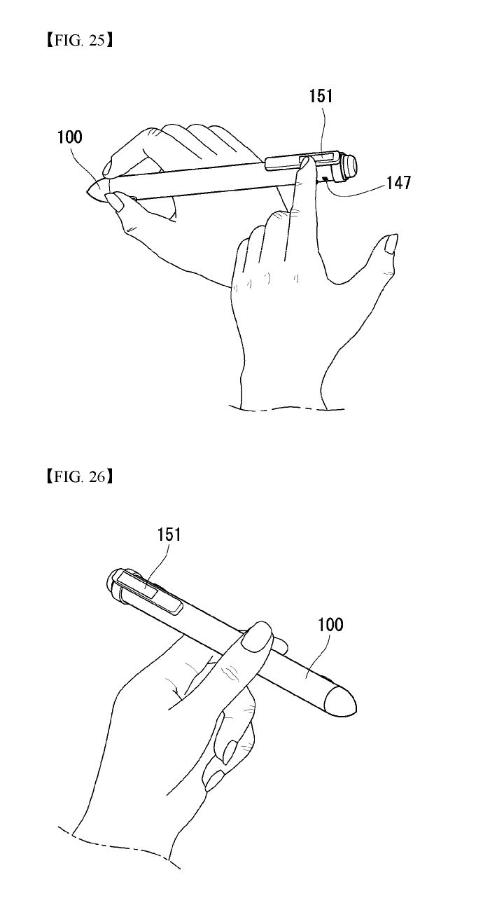

FIG. 25 illustrates another example of operation of the electronic device according to some embodiments of the present invention.

The user may write while using the electronic device 100. Here, the user may gaze at the display 151 while writing in order to use a function other than handwriting. The eye-tracking sensor 147 can sense the gaze of the user and the controller 180 can switch the electronic device 100 to a control mode. When the user touches the display 151 or performs a predetermined operation to complete control of the electronic device 100, the user may no longer need to gaze at the display 151. When the user looks away from the display 151, the eye-tracking sensor 147 senses the gaze of the user and the controller 180 can switch the electronic device 100 to the handwriting mode.

Accordingly, the user can operate the electronic device only by gazing at the electronic device.

FIG. 26 illustrates another example of operation of the electronic device according to some embodiments of the present invention.

The user may grip the electronic device 100 nearly horizontally while handwriting using the electronic device 100 and maintain this state. When this state is maintained for a predetermined time or longer, the controller 180 can switch the electronic device 100 from the handwriting mode to the control mode. Here, the user needs to recognize a situation in which the electronic device 100 is being controlled and thus the display 151 can be activated. The user can select a menu in the control mode and end the control mode by manipulating the display 151 or through a specific motion.

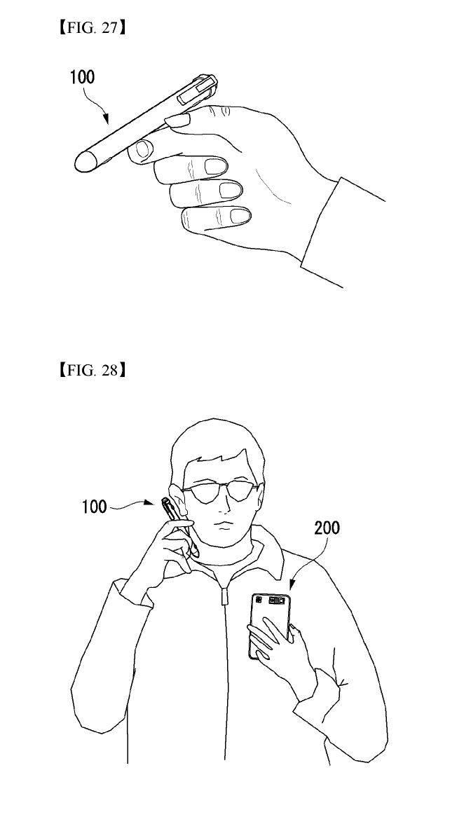

FIG. 27 illustrates another example of operation of the electronic device according to some embodiments of the present invention and FIG. 28 illustrates another example of operation of the electronic device according to some embodiments of the present invention.

As illustrated in FIG. 27, the user may perform a specific operation by rotating the electronic device 100. An action of manipulating a writing tool by hand can be a normal action of a person. Functions of the electronic device 100 can be controlled by such a natural action of a person according to some embodiments of the present invention, and thus user convenience or use sensibility can be enhanced.

The electronic device according to some embodiments of the present invention may be used by being synchronized with other electronic devices. For example, as illustrated in FIG. 28, the user can make a voice call by synchronizing the electronic device 100 with the mobile terminal 200. Particularly, when the user intends to make a video call, the speaker 107 and the microphone 104 of the electronic device 100 can be brought to the ear and mouth of the user, improving call quality.

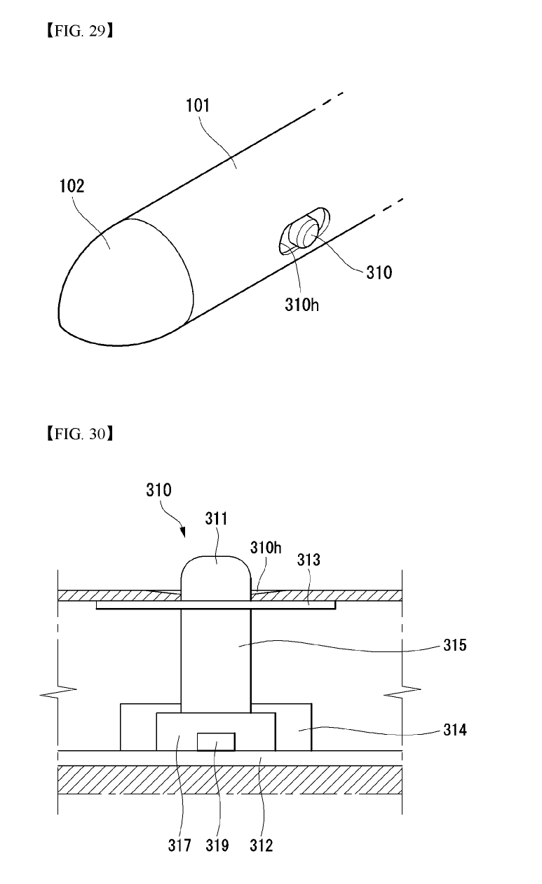

FIGS. 29 and 30 illustrate an example of a switch according to some embodiments of the present invention.

Referring to FIG. 29, a switch 310 may be provided to one side of the housing 101. Here, the switch 310 may be positioned in proximity to the tip 102. When the user intends to create content through a motion or trajectory of the tip 102, convenience of user manipulation can be improved. The housing 101 may have a switch hole 310h through which an operating part 311 protrudes.

Referring to FIG. 30, the switch 310 may include the operating part 311, a plate 313, a connector 315, a switching space 314, a transfer part 317, an electrode 319, and a module part 312. The operating part 311 can protrude to the outside of the housing 101 for manipulation convenience of the user when the user creates content. The operation range of the switch 310 can be limited according to the switch hole 310h and the operating part 311. The plate 313 can cover a gap that may be generated as the operating part 311 moves in the switch hole 310h. The connector 315 can extend from the operating part 311 to the inside of the housing 101. The electrode 319 and the module part 312 can be electrically connected to each other or separated from each other according to relative movement thereof. Mode switching can be controlled according to electrical contact between the electrode 319 and the module part 312. The module part 312 can be connected to the PCB. More specifically, the module part 312 can be connected to the controller 180. The transfer part 317 can be formed to surround the electrode 319 such that a force transferred through the operating part 311 and the connector 315 is delivered to the electrode 319 and thus the electrode 319 can move relative to the module part 312. The housing 101 may include the switching space 314 depending on the operation range of the transfer part 317.

Accordingly, the user can easily perform mode switching between the first mode and the second mode by operating the switch 310.

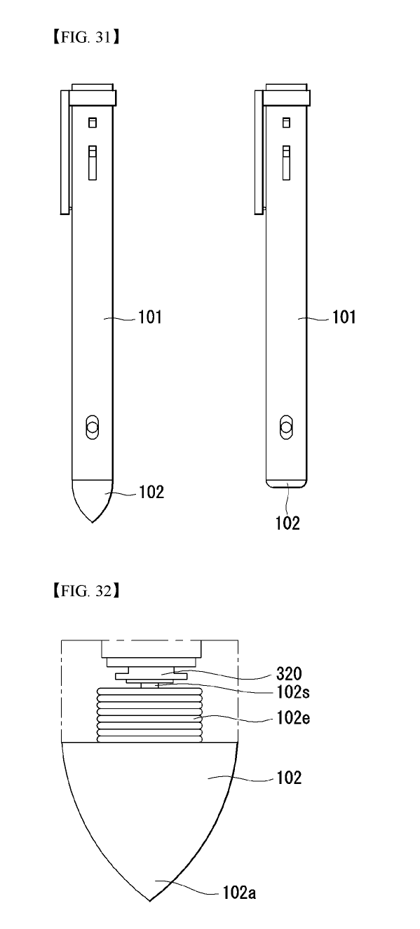

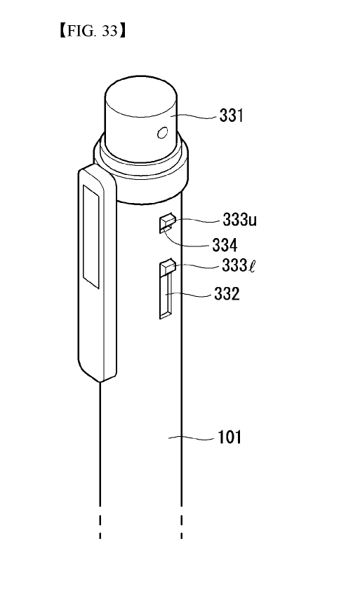

FIGS. 31 and 32 illustrate another example of a switch according to some embodiments of the present invention.

Referring to FIG. 31, the tip 102 provided to one end of the housing 101 may be deformed. To this end, the tip 102 may be made of a flexible material. For example, the tip 102 can be made of rubber, sponge, memory foam, or the like. When the user pushes the tip 102 against a surface, for example, a writing surface, the shape of the tip 102 can be deformed.

Referring to FIG. 32, the tip 102 can be coupled to one end of the housing 101. The tip 102 may include a coupling part 102e and a contact part 102s. The coupling part 102e may have a male screw shape for coupling one end of the housing 101 and the tip 102. The housing 101 may have a female screw shape corresponding to the coupling part 102e. The contact part 102s may be mechanically connected to an end 102a of the tip 102. That is, a motion or deformation of the end 102a of the tip 102 can be transferred to the contact part 102s. The contact part 102s can contact a switch 320. For example, the switch 320 may be the pressure sensor 149. That is, when the user pushes the end 102a of the tip 102 against a certain surface, for example, the writing surface to cause the tip to be deformed, the switch 320 can be operated.

Accordingly, the user can easily perform mode switching between the first mode and the second mode by operating the switch 320.

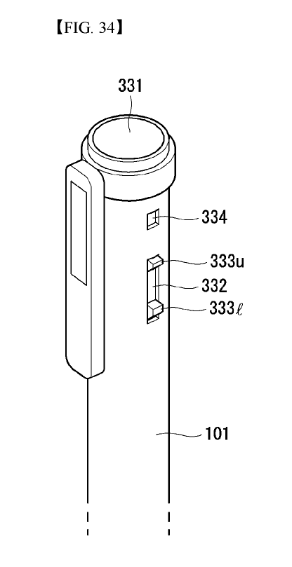

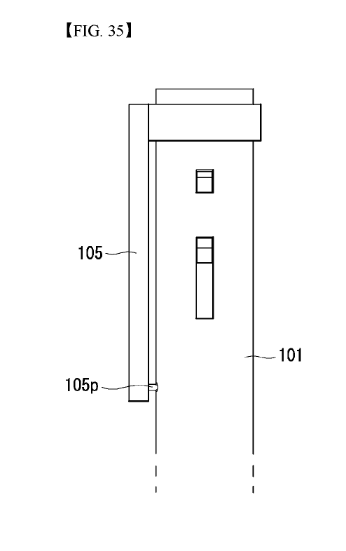

FIGS. 33 and 34 illustrate another example of a switch according to some embodiments of the present invention.

Referring to FIG. 33, the switch may include a cap 331 and a retaining part 333. The cap 331 may be positioned at one end of the housing 101. The cap 331 can be moved from one end of the housing 101 to the inside of the housing 101. The retaining part 333 may include a first protrusion 3331 and a second protrusion 333u. The housing 101 may include a first retaining hole 332 and a second retaining hole 334 corresponding to the first protrusion 3331 and the second protrusion 333u. The first retaining hole 332 may be formed longer than the second retaining hole 334. In addition, the second retaining hole 334 may be formed closer to the cap 331 than the first retaining hole 332. The first protrusion 3331 can protrude in the first retaining hole 332 and the second protrusion 333u can protrude in the second retaining hole 334. For example, the switch illustrated in FIG. 33 may be in an OFF state.

Referring to FIG. 34, when the user pushes the cap 331, the switch can be moved. When the cap 331 is moved to the inside of the housing 101, the second protrusion 333u positioned in the second retaining hole 334 can be moved to the first retaining hole 332. Further, the first protrusion 3331 positioned at the upper end of the first retaining hole 332 can be moved to the lower end thereof. Accordingly, the cap 331 can remain in the illustrated state. For example, the switch shown in FIG. 34 may be in an ON state.

Therefore, the user can easily perform mode switching between the first mode and the second mode by operating the switch.

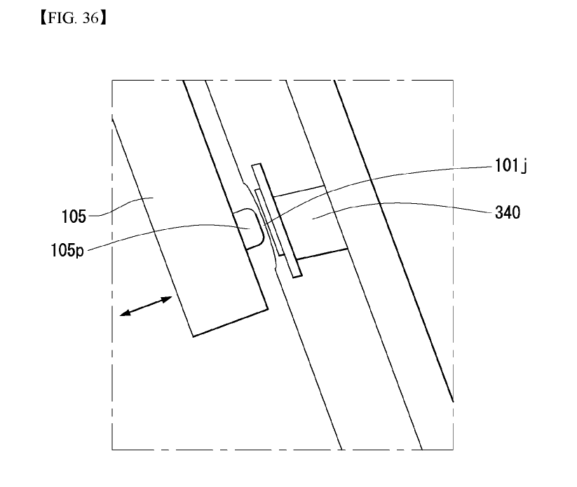

FIGS. 35 and 36 illustrate another example of a switch according to some embodiments of the present invention.

As described above, the pin 105 coupled to the housing 101 to be fixed thereto can be elastically moved within a predetermined range. Referring to FIG. 35, the pin 105 may include a protrusion 105p. The protrusion 105p may be positioned at one end of the pin 105 in consideration of the operating range of the pin 105 according to elasticity. For example, the protrusion 105p may be positioned opposite the fixed side of the pin 105. The protrusion 105p can protrude to the housing 101.

Referring to FIG. 36, a switch 340 may be positioned inside of the housing 101 and face the protrusion 105p. For example, the switch 340 may be the pressure sensor 149. To expose the switch 340, an opening 101j may be formed in the housing 101. When the user pushes the portion of the pin 105 corresponding to the protrusion 105p, the protrusion 105p can contact the switch 340 and thus the switch 340 can be operated. That is, when the user pushes a certain portion of the pin 105, mode switching between the first mode and the second mode can occur.

Therefore, the user can easily perform mode switching between the first mode and the second mode by operating the switch 340.

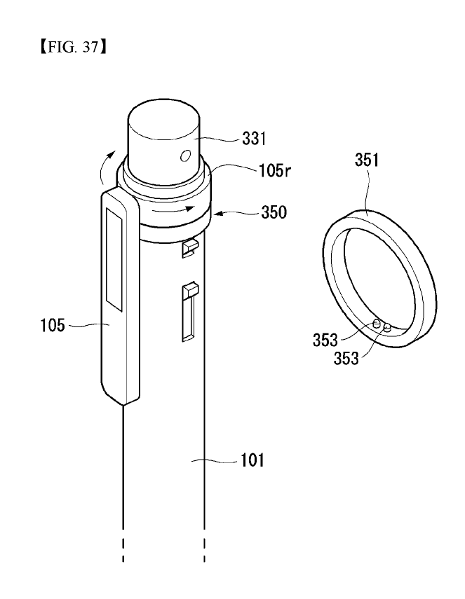

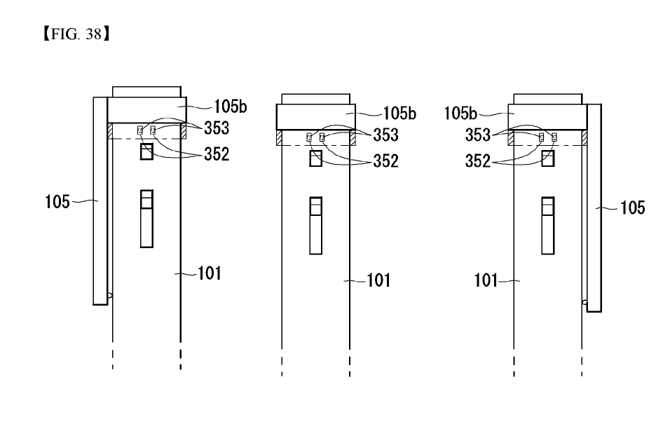

FIGS. 37 and 38 illustrate another example of a switch according to some embodiments of the present invention.

Referring to FIG. 38, the pin 105 may include a pin rotating part 105b. The pin rotating part 105b can fasten the pin 105 to the housing 101 such that the pin 105 can rotate around the housing 101. To this end, the pin rotating part 105b may be a ring. Referring to FIG. 37, a switch 350 may include a rotating part 351 and a contact part 353. The rotating part 351 may be formed in a ring shape and rotated together with the pin rotating part 105b. The contact part 353 may be formed at one side of the rotating part and protrude therefrom. The rotating part 351 and the contact part 353 may be formed of an electrically conductive material. More specifically, when the rotating part 351 has a ring shape, the contact part 353 can protrude from the inner side of the ring. A plurality of contact parts 353 may be formed. Referring to FIG. 38, the housing 101 may include a terminal 352 or an electrode. A plurality of terminals 352 may be provided and may be formed of an electrically conductive material.

Referring to FIG. 38, the pin 105 can rotate in the housing 101 and the switch 350 can also rotate along with the pin 105. The terminals 352 may be paired and a plurality of terminal pairs 352 may be provided. For example, a plurality of terminal pairs 352 may be divided into first, second and third modes. Accordingly, when the user rotates the pin 105 clockwise from the housing 101, the contact part 353 can be positioned corresponding to the pair of terminals 352 in the first mode. When the user further rotates the pin 105 clockwise from the housing 101, the contact part 353 can be positioned corresponding to the pair of terminals 352 in the second mode. When the user further rotates the pin 105 clockwise from the housing 101, the contact part 353 can be positioned corresponding to the pair of terminals 352 in the third mode. For example, the first mode may be a writing mode, the second mode may be a control mode and the third mode may be a holding mode.

Accordingly, the user can easily switch modes by operating the switch 350.

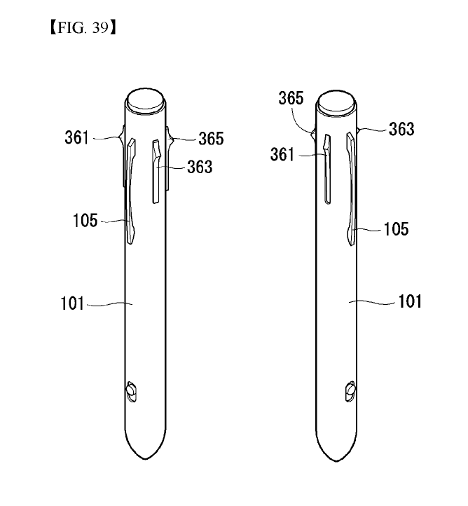

FIG. 39 illustrates another example of a switch according to some embodiments of the present invention.

The housing 101 may have a plurality of grooves formed therein. The plurality of grooves may be formed at the circumference of the housing 101. Here, the grooves can be disposed at predetermined intervals. The housing 101 may include a plurality of switches 361, 363 and 363. The plurality of switches 361, 363 and 365 may be positioned in the respective grooves. For example, three switches 361, 363 and 363 can be provided. One switch 361 may be used to set the first mode, another switch 363 may be used to set the second mode and the remaining switch 365 may be used to set the third mode. The user can switch modes by operating the three switches 361, 363 and 365. For example, the first mode may be a writing mode, the second mode may be a control mode and the third mode may be a standby mode.

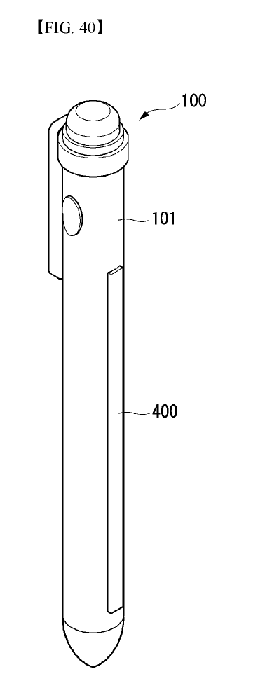

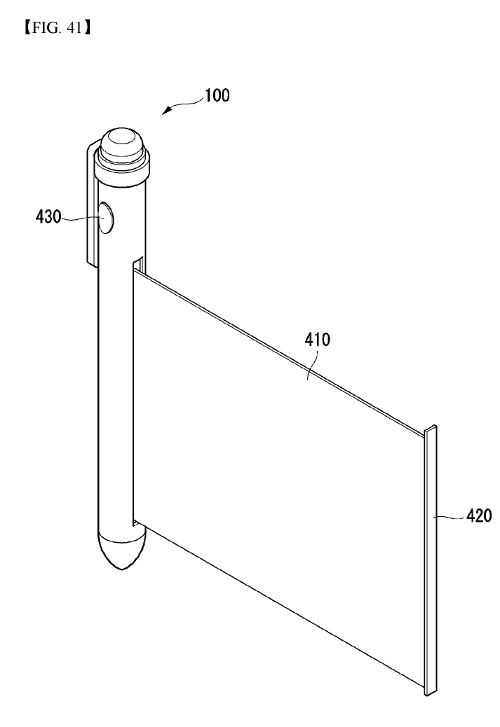

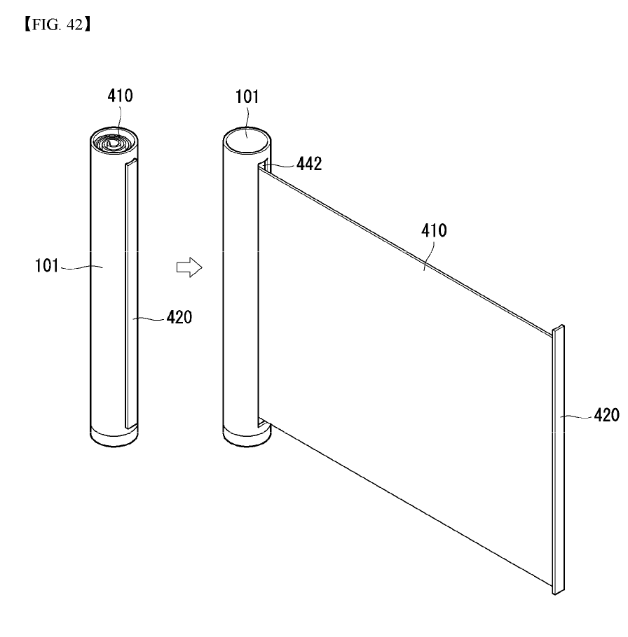

FIG. 40 illustrates an example of a display according to some embodiments of the present invention.

A display 400 may be provided to the outer surface of the housing 101. The display 400 may be formed long and narrow from the upper side to the lower side of the outer surface of the housing 101. A single display 400 may be provided or a plurality of displays 400 may be provided. The display 400 can display functions of the electronic device 100. For example, when the user writes using the electronic device 100, the display 400 can display the writing mode. When the user makes a voice call using the electronic device 100, the display 400 can display calling. The display 400 may be connected to another display.

FIG. 41 illustrates another example of a display according to some embodiments of the present invention.

The electronic device 100 may include a first display 410 and a second display 420. The first display 410 may be a flexible display. For example, the first display 410 may be an OLED display. The first display 410 may be rolled inside of the housing 101 and may be unrolled and extended to the outside of the housing 101. The second display 420 may be provided to one side of the first display 410. The second display 420 may be provided to the side of the first display 410 when the user views the first display 410. Accordingly, the first and second displays 410 and 420 may provide information for different purposes. For example, the first display 410 can display information related to the currently used function of the electronic device 100 and the second display 420 can display information related to other functions of the electronic device 100. Meanwhile, the electronic device 100 may include a button 430. The button 430 will be described below in detail.

FIG. 42 illustrates another example of a display according to some embodiments of the present invention. The electronic device 100 may include the housing 101, the first display 410 and the second display 420.

The housing 101 may be a cylinder having an opening 442 formed in one side thereof. The opening 442 may be elongated to extend from the upper side to the lower side of the housing 101. The opening 442 may be formed slightly longer than the length of the cross section of the first display 410. The first display 410 may be rolled inside of the housing 101 and may be unrolled to the outside of the housing 101 through the opening 442. The second display 420 may be connected to the first display 410 and positioned in the opening 442 while the first display 410 is rolled inside of the housing 101. When the first display 410 is unrolled to the outside of the housing 101, the second display 420 may be separated along with the first display 410 from the opening 442.

The state in which the first display 410 is rolled inside of the housing 101 may be the first mode. The state in which the first display 410 is exposed to the outside of the housing 1201 may be the second mode. The second display 420 can form a part of the outer surface of the housing 101 in the first mode. The second display 420 can be positioned at one end of the first display 410 exposed to the outside of the housing 101.

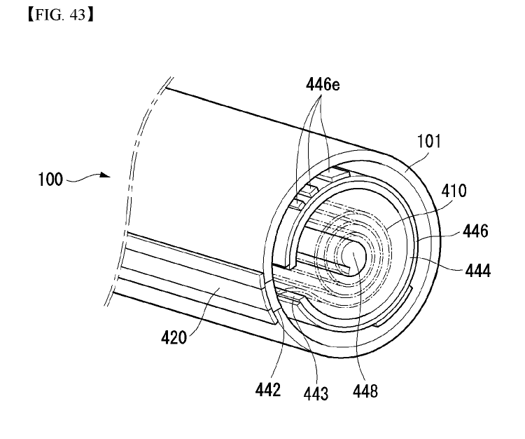

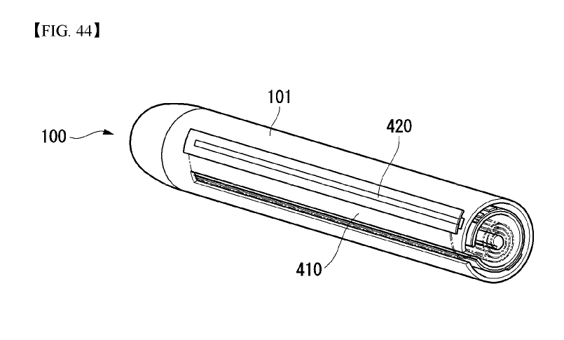

FIG. 43 illustrates an example of the cross section of the display according to some embodiments of the present invention.

The electronic device may further include a shell 444. The shell 444 may be positioned inside of the housing 101. The shell 444 may have a smaller diameter than the housing 101. The shell 444 may have a similar shape to the housing 101. That is, the shell 444 may be a cylinder having an opening 443 formed in one side thereof. The opening 443 may be elongated to extend from the upper side to the lower side of the shell 444. The opening 443 may be slightly longer than the length of the cross section of the first display 410. The opening 443 of the shell 444 may face the opening 442 of the housing 101.

A PCB 446 may be positioned between the housing 101 and the shell 444. The PCB 446 may be an FPCB. The PCB 446 may be positioned to contact the outer surface of the shell 444. Electronic elements 446e may be mounted on the PCB 446. Accordingly, a space for the electronic elements 446e can be secured.

A shaft 448 may be positioned inside of the shell 444. On end of the first display 410 may be connected to the shaft 448. Here, one end of the first display 410 may be fixed to the shaft 448. The shaft 448 may rotate inside of the shell 444. In other words, the shaft 448 can rotate inside of the shell 444, and one end of the first display 410 is fixed to the shaft 448 and thus the first display 410 can be rolled onto the outer surface of the shaft 448 according to rotation of the shaft 448.

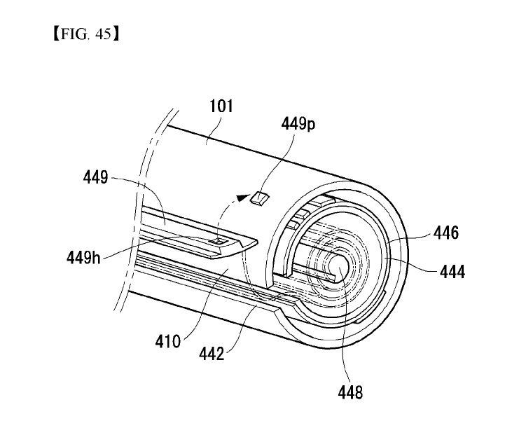

FIGS. 44 and 45 illustrate another example of the display according to some embodiments of the present invention.

Referring to FIG. 44, at least part of the first display 410 may be exposed to the outside of the housing 101. The first display 410 can display information upon being exposed to the outside of the housing 101. The first display 410 may be activated when exposed to the outside of the housing 101. Here, the displayed information may be a state of the electronic device 100. For example, content such as a clock, text reception notification, unanswered call notification, low battery voltage warning and a schedule may be displayed. The second display 420 may be activated or deactivated. When at least part of the first display 410 is exposed to the outside of the housing 101, the mode of the electronic device can be switched to the second mode. For example, the user can use the writing mode in a state in which the first display 410 is positioned inside of the housing 101. The user may expose at least part of the first display 410 to the outside of the housing 101 while using the writing mode, and thus the writing mode can be switched to the control mode.

Referring to FIG. 45, the electronic device 100 may include a cover 449. The cover 449 may be connected to one end of the first display 410. Here, one end of the first display 410 may be fastened to the cover 449. The cover 449 may be composed of a rear side inserted into the opening 442 of the housing 101 and a flat front side. A hole 449h may be formed at one side of the rear side of the cover 449. A protrusion 449p corresponding to the hole 559h may be formed in the housing 101. The protrusion 449p of the housing 101 can be fitted into the hole 449h of the cover 449 to maintain a state in which at least part of the first display 410 is exposed to the outside of the housing 101.

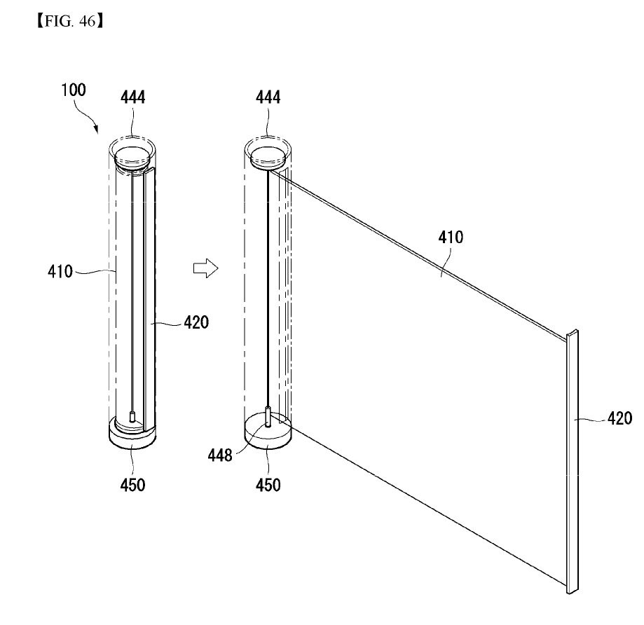

FIG. 46 illustrates another example of the display according to some embodiments of the present invention. The electronic device 100 may include a motor 450.

The motor 450 may be positioned at one end of the shell 444. The motor 450 may be connected to the shaft 448. The motor 450 can rotate the shaft 448. When the motor 450 rotates the shaft 448, the first display 410 rolled on the shaft 448 can be unrolled and thus can be exposed to the outside of the housing 101. That is, the first mode can be switched to the second mode according to the motor 450.

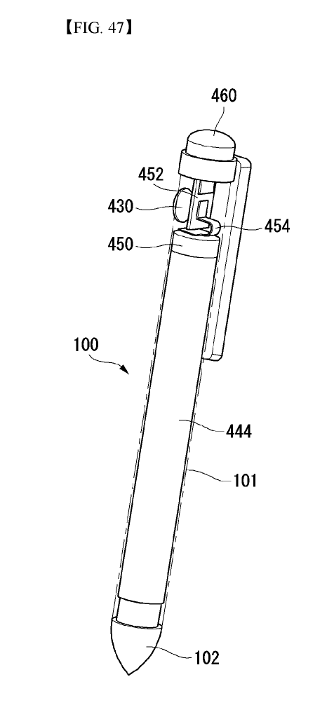

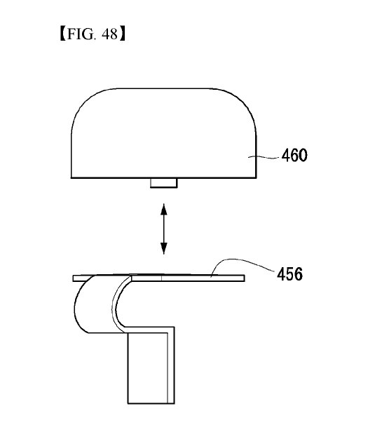

FIGS. 47 and 48 illustrate an example of the electronic device according to some embodiments of the present invention. The electronic device 100 may include the motor 450, a wire 454, a PCB 452, the button 430 and a power supply 460.

Referring to FIG. 47, the motor 450 may be positioned inside of the housing 101 opposite the tip 102. The shell 444 may be positioned between the motor 450 and the tip 102. The power supply 460 may be provided to one end of the housing 101 opposite the tip 102. The PCB 452 for operating the display may be provided inside of the housing 101 between the motor 450 and the power supply 460. The PCB 452 can be provided with current from the power supply 460 to operate the motor 450. The motor 450 may be electrically connected to the PCB 452 through the wire 454. The button 430 can control operation of the motor 450. For example, the button 430 may be electrically connected to the PCB 452 to switch operation of the motor 450. The button 430 may include the finger scan sensor 146. Accordingly, when the user pushes the button 430, the button 430 can recognize a fingerprint of the user to control operation of the motor 450. When an unregistered user pushes the button 430, the motor 450 may not be operated.

Referring to FIG. 48, the power supply 460 may be electrically connected to the PCB 452 of FIG. 47 through a wire 456. In the meantime, the power supply 460 may be initially set to maintain a predetermined gap from the wire 456 and the housing 101. When the power supply 460 is pushed by a predetermined force, the power supply 460 can be electrically connected to the wire 456. Accordingly, the user may apply external force to the power supply 460, for example, push the power supply 460, to supply power to the motor 450.

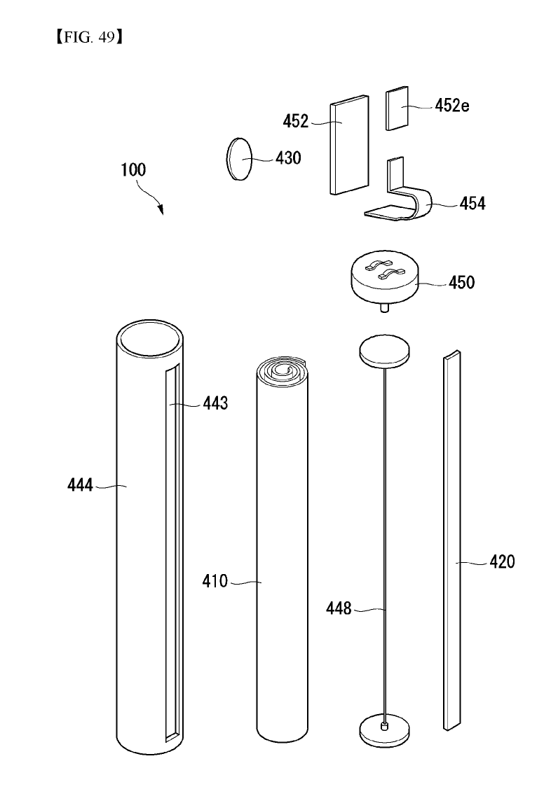

FIG. 49 is an exploded diagram of the display according to some embodiments of the present invention. This figure can be referred to for better understanding of the display according to the aforementioned embodiments of the present invention. FIG. 49 illustrates the shell 444, the opening 443, the first display 410, the shaft 448, the second display 420, the motor 450, the wire 454, the PCB 452, the electronic element 452e and the button 430. The second display 420 may be called a sub-display.

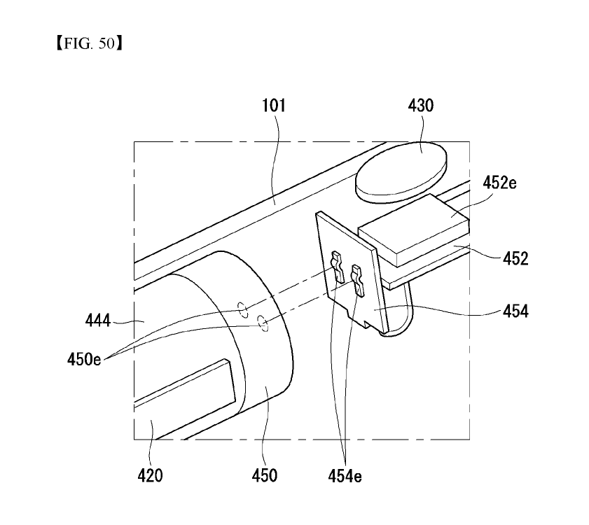

FIG. 50 illustrates an example of the inside of the housing according to some embodiments of the present invention. The same parts as the above description are designated by the same reference numerals and description thereof is omitted. FIG. 50 illustrates the housing 101, the shell 444, the second display 420, the motor 450, the button 430, the wire 454, the PCB 452, the electronic elements 452e, an electrode 450e and a contact part 454e.

The wire 454 may include the contact part 454e formed at the face thereof facing the motor 450. A plurality of contact parts 454e may be provided and paired. The motor 450 may include the electrode 450e at a position facing the contact part 454e. A plurality of electrodes 450e may be provided and paired. The motor 450 may be inserted into the housing 101 and connected to the PCB 452. Here, a pair of electrodes 450e and a pair of contact parts 454e can electrically connect the motor 450 to the PCB 452.

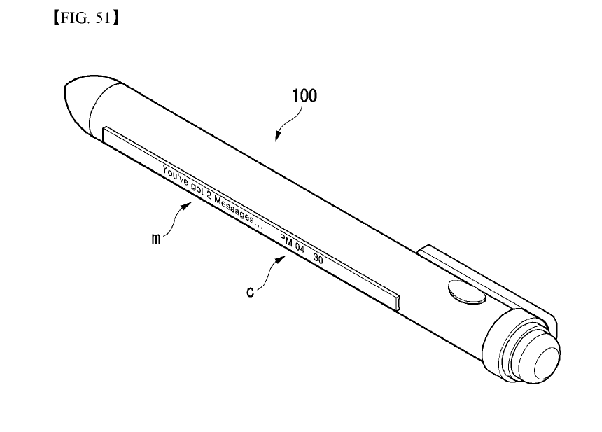

FIGS. 51 to 59 illustrate examples of operation of the electronic device according to some embodiments of the present invention.

Referring to FIG. 51, as described above with reference to FIG. 15, the electronic device 100 can execute a message transmission/reception function, a clock function and the like. The electronic device 100 may display whether a message is received (m), a clock (c) and the like through the second display 420. The second display 420 may be activated upon arrival of a message during the writing mode. Accordingly, the user can check a notification displayed through the second display 420 while using the electronic device 100 in the writing mode, switch from the writing mode to the control mode and confirm the notification. A state in which the first display 410 is positioned inside of the housing 101 may be a first state.

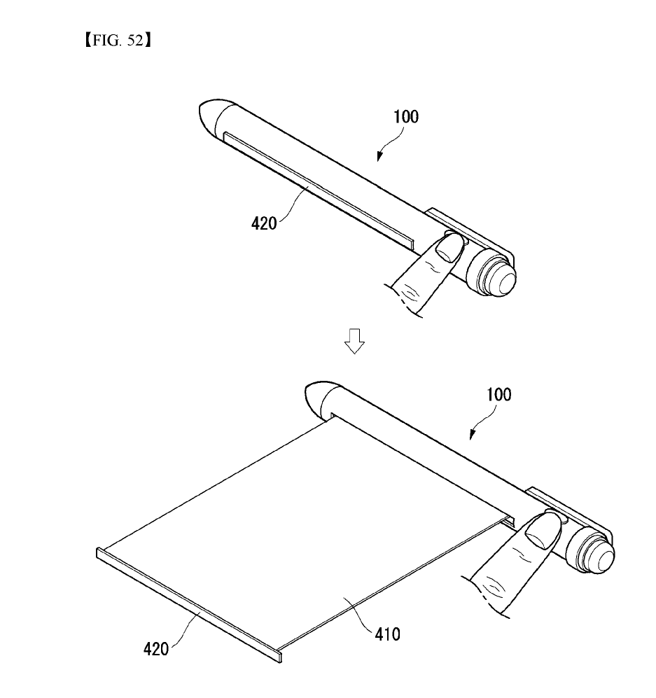

Referring to FIG. 52, the user can unroll the first display by pushing the button. When the user pushes the button, the first display 410 can be exposed to the outside of the housing 101 according to the aforementioned operation of the motor 450. Here, the electronic device 100 can be switched from the writing mode to the control mode. When the first display 410 is exposed to the outside and activated, the second display 420 may be deactivated or may also be activated simultaneously. A state in which at least part of the first display 410 is exposed to the outside of the housing 101 may be a second state.

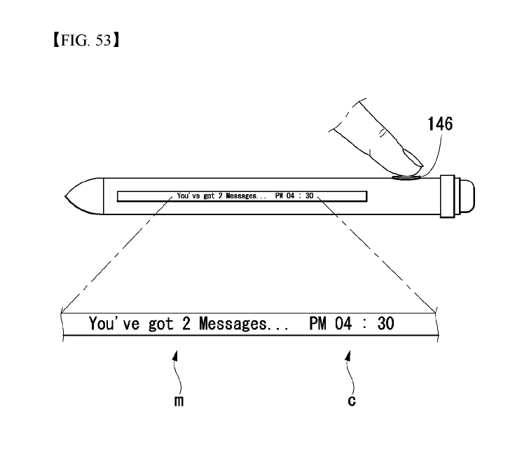

Referring to FIG. 53, activation of the second display 420 may be achieved only when a fingerprint of the user is recognized. The user may set the second display 420 such that the second display 420 is activated after the finger scan sensor 146 recognizes a registered fingerprint of the user. Accordingly, it is possible to prevent personal information of the user from being exposed by the electronic device 100 without notice. Recognition of a fingerprint of the user may be performed not only in the control mode but also in the writing mode. Mode switching between the writing mode and the control mode can be performed according to user fingerprint recognition as described above.

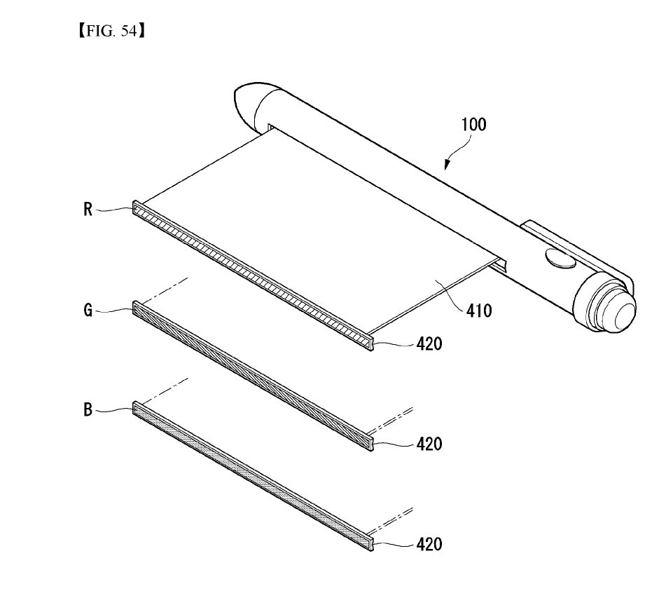

Referring to FIG. 54, the second display 420 may display various colors. For example, the second display 420 can display red, green and blue. Red may indicate an unanswered call, green may indicate application update and blue may indicate text message reception. Accordingly, the user can conveniently check the state of the electronic device 100. In addition, red may indicate a low battery voltage and blue may indicate fully charged battery according to user setting. Various colors displayed by the second display 420 may be set in various manners.

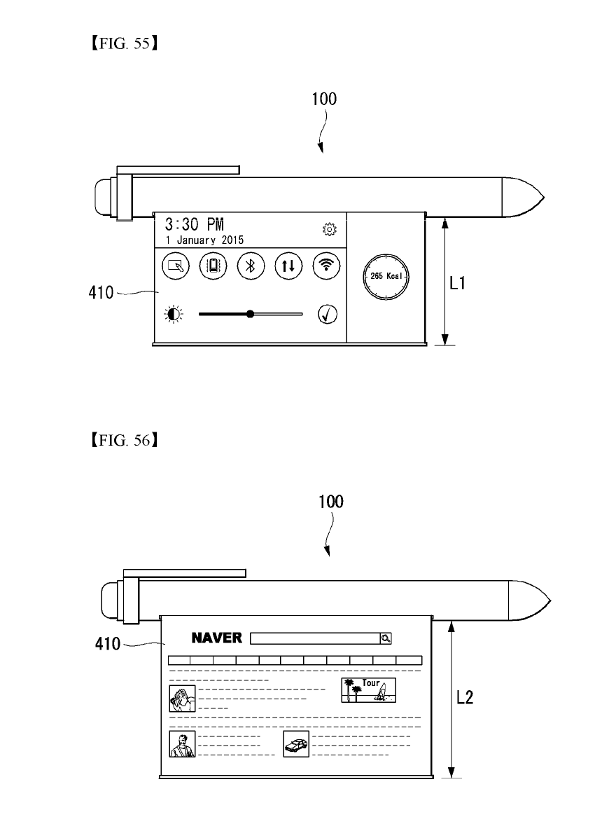

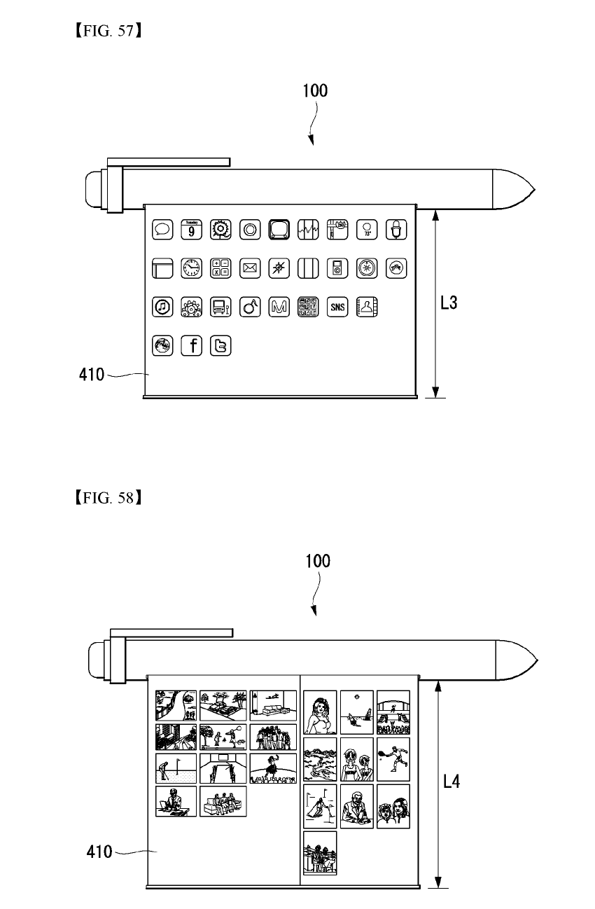

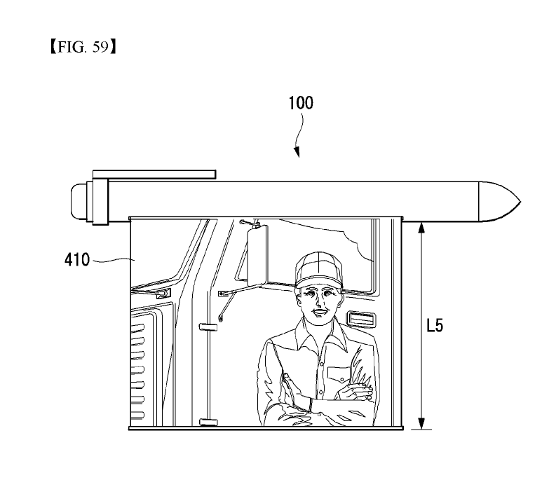

Referring to FIGS. 55 to 59, the first display 410 may display different pieces of content depending on lengths thereof exposed to the outside. For example, the first display 410 may be exposed to the outside by lengths L1, L2, L3, L4 and L5. L1 may correspond to a state in which the first display 410 is unrolled by one revolution to be exposed to the outside and L5 may correspond to a state in which the first display 410 is unrolled by five revolutions to be exposed to the outside. That is, the exposed length of the first display 410 can be set depending on how many revolutions the first display 410 is unrolled in the rolled state inside of the electronic device 100, and the first display 410 can display different pieces of content depending on exposed lengths thereof. FIG. 55 shows that the first display 410 is exposed to the outside by length L1 to display setting of the electronic device 100. FIG. 56 shows that the first display 410 is exposed to the outside by length L2 to display a search window. FIG. 57 shows that the first display 410 is exposed to the outside by the length L3 to display applications of the electronic device 100. FIG. 58 shows that the first display 410 is exposed to the outside by the length L4 to display images. FIG. 59 shows that the first display 410 is exposed to the outside by the length L5 to display a moving image.

The above-described embodiments or other embodiments of the present invention are not exclusive or discriminated. Configurations or functions of the above-described embodiments or other embodiments of the present invention may be jointly used or combined.

The above-described present invention can be implemented with computer-readable code in a program recorded medium. The computer-readable medium may include all kinds of recording devices capable of storing data readable by a computer system. Examples of the computer-readable medium may include an HDD (Hard Disk Drive), an SSD (Solid State Drive), an SDD (Silicon Disk Drive), a ROM, a RAM, a CD-ROM, magnetic tapes, floppy disks, optical data storage devices, and the like and also include such a carrier-wave type implementation such as transmission over the Internet. Furthermore, the aforementioned computer may include the controller of the electronic device. Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

1-20. (canceled)

21. An electronic device comprising:
an extendable elongated housing;
a tip coupled to one end of the housing;
a motion sensor located at at least one side of the housing; and
a controller configured to:
operate in at least a first mode or a second mode; and
perform mode switching between the first mode and the second mode when an operation by a user sensed via the motion sensor in the first or second mode corresponds to a preset operation,
wherein in the first mode, content is recorded in a memory, the content corresponding to a motion of the tip or the housing generated according to a first operation by the user sensed via the motion sensor, and
wherein in the second mode, a specific function is performed based on a second operation by the user.

22. The electronic device according to claim 21, wherein the second operation is sensed via the motion sensor and the specific function corresponds to a motion of the tip or the housing generated based on the second operation.

23. The electronic device according to claim 21, wherein:
the motion sensor comprises an eye-tracking sensor; and
the controller is further configured to perform the mode switching when a preset gaze of the user is sensed via the eye-tracking sensor.

24. The electronic device according to claim 21, wherein:
the motion sensor comprises at least a gyro sensor or an acceleration sensor; and
the controller is further configured to perform the mode switching when the preset operation is sensed via at least the gyro sensor or the acceleration sensor.

25. The electronic device according to claim 24, wherein the preset operation comprises at least holding the housing in a horizontal state for at least a first threshold period of time, holding the housing in a vertical state for at least a second threshold period of time, or rotating or shaking the housing according to a preset pattern.

26. The electronic device according to claim 21, wherein:
the motion sensor comprises a finger scan sensor located in proximity to the tip; and
the controller is further configured to perform the mode switching when a preset fingerprint is recognized via the finger scan sensor.

27. The electronic device according to claim 21, wherein:
the motion sensor comprises a pressure sensor contacting the tip; and
the controller is further configured to perform the mode switching when a force that is greater than a threshold level is applied to the tip and sensed by the pressure sensor.

28. The electronic device according to claim 21, wherein content corresponding to a trajectory according to a motion of the tip is stored in the memory based on the first operation.

29. The electronic device according to claim 21, wherein the specific function is one of a plurality of functions in a group.

30. The electronic device according to claim 29, wherein the plurality of functions comprise at least two of calling, message transmission/reception, contact display, alarm, playback, recording, and e-mail transmission/reception.

31. The electronic device according to claim 21, wherein the controller is further configured to perform the mode switching when the preset operation is maintained for at least a preset time.

32. The electronic device according to claim 21, further comprising a nib coupled with the tip and configured to release ink.

33. The electronic device according to claim 21, further comprising a wireless communication unit configured to:
transmit content stored in the memory to at least one other device; or
receive content from the at least one other device.

34. The electronic device according to claim 21, wherein the housing has a cylindrical shape and further comprising a display surrounding an outer surface of the housing.

35. The electronic device according to claim 34, wherein the controller is further configured to cause scrolling of content displayed on the display when the housing is rotated in a direction in which the housing is extended as a shaft.

36. The electronic device according to claim 21, wherein:
the motion sensor comprises an optical sensor for measuring a motion or a trajectory of the tip using a laser; and
the controller is further configured to store content corresponding to the motion or trajectory of the tip in the memory.

37. The electronic device according to claim 21, further comprising a display on an outer surface of the housing,
wherein the controller is further configured to activate the display when switching between the first mode and the second mode is performed.

38. The electronic device according to claim 21, further comprising:
a pin fixed to one side of the housing; and
a display on a front side of the pin.

39. The electronic device according to claim 21, further comprising a switch on an outer surface of the housing,
wherein the preset operation comprises manipulating the switch.

40. The electronic device according to claim 21, wherein:
the housing has a triangular cross section and comprises a plurality of displays on an outer surface;
the motion sensor comprises at least a gyro sensor, an acceleration sensor, or an angular acceleration sensor; and
the controller is further configured to activate at least one of the plurality of displays based on a gripping state of the user sensed via the motion sensor.
